(19) United States
(12) Patent Application Publication
(10) Pub. No.: US 2016/0373984 A1
(43) Pub. Date: Dec. 22, 2016

(54) MOBILE COMMUNICATION APPARATUS AND RADIO COMMUNICATION METHOD

(71) Applicant: FUJITSU LIMITED, Kawasaki-shi (JP)

(72) Inventor: Yasushi Hara, Kunitachi (JP)

(73) Assignee: FUJITSU LIMITED, Kawasaki-shi (JP)

(21) Appl. No.: 15/180,769

(22) Filed: Jun. 13, 2016

(30) Foreign Application Priority Data
Jun. 18, 2015 (JP) 2015-123155

(51) Int. Cl. H04W 36/18; H04W 36/08

(52) U.S. Cl. CPC H04W 36/18; H04W 36/08; H04W 88/08

(57) ABSTRACT

A first radio communication interface performs communication over a first radio communication network. A second radio communication interface executes a first scan to detect an access point of a second radio communication network and measure a signal level of reception signals received from the detected access point. When the signal level calculated in the first scan is smaller than or equal to a first threshold, but exceeds a second threshold, a processor causes the second radio communication interface to execute a second scan that specifies an identifier of the detected access point so as to restrict scanning to a smaller range of access points than the first scan. When a signal level calculated in the second scan for the detected access point exceeds the first threshold, the processor switches a path of the communication from the first radio communication network to the second radio communication network.

### CROSS-REFERENCE TO RELATED APPLICATION

This application is based upon and claims the benefit of priority of the prior Japanese Patent Application No. 2015-123155, filed on Jun. 18, 2015, the entire contents of which are incorporated herein by reference.

### FIELD

The embodiments discussed herein relate to a mobile communication apparatus and a radio communication method.

### BACKGROUND

Mobile communication networks of today allow the combined use of wide area services (e.g., cellular network) and local area services (e.g., wireless local area network, or wireless LAN). A wireless LAN may have a number of access points (also called base stations) with radio interface circuits to accept connections from the users roaming around various places. For example, a mobile communication device scans radio communication channels of wireless LAN to detect nearby access points available for connection. When a detected access point is found to satisfy some conditions (e.g., reception signal level exceeds a threshold), the mobile communication device makes a connection to that access point automatically or according to user commands.

Some mobile communication devices are capable of switching communication paths between a wide-area radio network and a local-area wireless network even in the middle of a communication session. For example, one proposed radio communication device performs a handover from a cellular network to a wireless LAN and the other way around, while continuing an ongoing communication session. This radio communication device makes an advanced registration in the cellular network when the device has started a communication session over the wireless LAN, thus enabling a fast handover from wireless LAN to cellular network. The proposed registration scheme consumes less electrical power, compared with the case in which a radio communication device has to be registered in both the wireless LAN and cellular network.

Another proposed technique provides a wireless terminal capable of handing over its communication from a wireless LAN to a code-division multiple access (CDMA) network. This wireless terminal produces a candidate list of access points and selects one access point from the candidate list on the basis of signal level measurements. The wireless terminal initiates a handover when the selected access point exhibits a higher signal level than the current access point, and only if the difference between their signal levels exceeds a predefined hysteresis level.

Also proposed in this technical field is a mobile terminal that switches from one wireless LAN to another wireless LAN. This mobile terminal achieves such switching by performing a handover from the current wireless LAN to a cellular network and then executing another handover from the cellular network to a new wireless LAN.

Still another proposed device is a mobile node capable of switching from a mobile network to a wireless LAN and vice versa. Specifically, the proposed mobile node changes its connection from a mobile network to a wireless LAN when the signal level of the wireless LAN exceeds a first threshold. The mobile node returns to the mobile network when the wireless LAN exhibits a drop of signal levels that falls below a second threshold that is smaller than the first threshold. When the signal level further drops below a third threshold, the mobile node starts active scans to seek other available access points.

See, for example, the following documents:
International Publication Pamphlet No. WO2005/006571
International Publication Pamphlet No. WO2005/041612
Japanese Laid-open Patent Publication No. 2006-80981
Japanese Laid-open Patent Publication No. 2007-251941

One thing to consider here is that the quality of communication would be degraded during a period immediately after a handover from a wide-area cellular network to a wireless LAN if that handover began at a point where the wireless LAN still exhibits a relatively low signal level. Similar quality degradation could also be experienced immediately before a handover to a wide-area cellular network if the mobile communication device waits until the signal from the current wireless LAN falls down to a sufficiently low level. Effects of such quality degradation will become prominent when the device is engaged in a realtime communication session such as Voice over Internet Protocol (VoIP) calls.

One possible solution for alleviating quality degradation in transient periods of a handover is to raise the threshold for determining signal levels of local radio communication networks. More specifically, the mobile communication device does not initiate a handover from the current wide area network to a local area network until the signal from the latter rises to a sufficient level. The mobile communication device also performs a handover to the wide area network before the local area network begins to exhibit a large drop of signal levels.

It has to be noted, however, that simply raising handover thresholds could lead to missing the opportunities for the mobile communication device to connect to an access point of a local area network. Suppose, for example, that the mobile communication device is in a communication session over a cellular network, while continuing broadcast scans at long intervals to seek any available access points. Once it fails to detect sufficiently high signal levels, the mobile communication device is unable to find any valid access point until the next broadcast scan is done. With such slow broadcast scans alone, the mobile communication device could lose track of received signal levels because the device may move a large distance during a long interval of broadcast scans. As another possibility, the mobile communication device may be surrounded by many nearby access points. In this case, the broadcast scans have to deal with all those access points, at the risk of missing some available access points.

### SUMMARY

In one aspect, there is provided a mobile communication apparatus including a first radio communication interface, a second radio communication interface, and a processor. The first radio communication interface performs communication over a first radio communication network. The second radio communication interface executes a first scan to detect an access point of a second radio communication network and measure a signal level of reception signals received from the detected access point. The processor is configured to perform a procedure including: causing the second radio communication interface to execute a second scan that specifies an identifier of the detected access point so as to restrict scanning to a smaller range of access points than the first scan, when the signal level calculated in the first scan is smaller than or equal to a first threshold, but exceeds a second threshold, and switching a path of the communication from the first radio communication network to the second radio communication network when a signal level calculated in the second scan for the detected access point exceeds the first threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a mobile communication apparatus according to a first embodiment;

FIG. 2 illustrates a radio communication system according to a second embodiment;

FIG. 3 is a block diagram illustrating an exemplary hardware configuration of a mobile communication apparatus;

FIG. 4 illustrates an example of access point connection in a handover environment;

FIG. 5 illustrates an example of access point connection in a single AP environment;

FIG. 6 illustrates an example of wireless LAN channels;

FIG. 7 is a block diagram illustrating exemplary functions of a mobile communication apparatus;

FIG. 8 illustrates an example of a connection record table and a threshold table;

FIG. 9 illustrates an example of a candidate channel table;

FIGS. 10 to 12 are first to third sequence diagrams illustrating an example of communication in a handover environment;

FIGS. 13 and 14 are first and second sequence diagrams illustrating an example of communication in a single AP environment;

FIGS. 15 to 19 provide a flowchart illustrating an exemplary procedure performed by a first radio communication unit;

FIG. 20 is a flowchart illustrating an exemplary procedure performed by a scanning control unit;

FIGS. 21 and 22 provide a flowchart illustrating an exemplary procedure performed by an AP management unit;

FIG. 23 is a flowchart illustrating an exemplary procedure performed by a handover control unit;

FIG. 24 is a flowchart illustrating an exemplary procedure performed by a cellular handover control unit; and

FIG. 25 is a flowchart illustrating an exemplary procedure performed by a second radio communication unit.

### DESCRIPTION OF EMBODIMENTS

Several embodiments will be described below with reference to the accompanying drawings.

### (a) First Embodiment

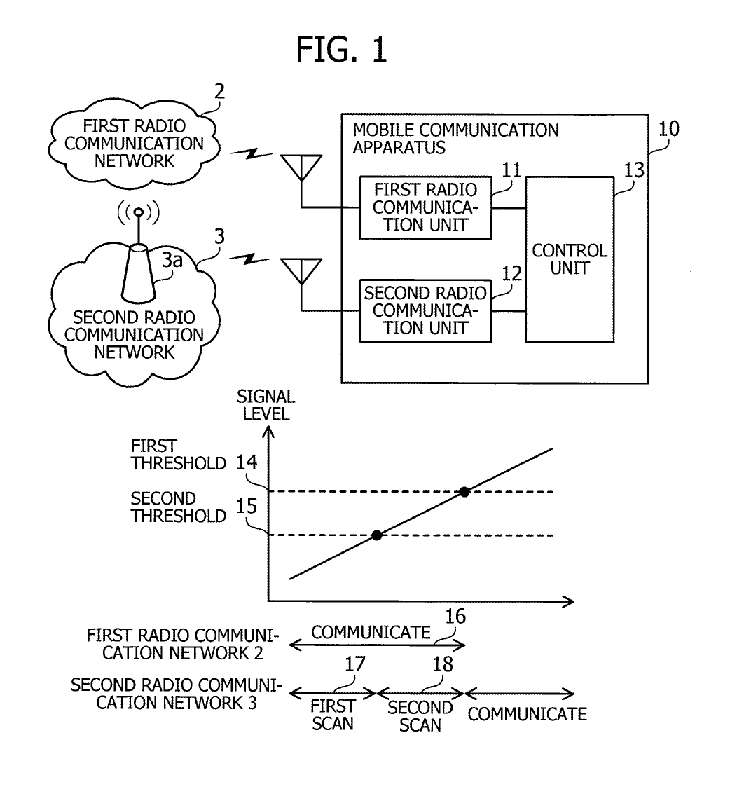

FIG. 1 illustrates a mobile communication apparatus according to a first embodiment. The illustrated mobile communication apparatus 10 of the first embodiment may use a first radio communication network 2 and a second radio communication network 3 in a selective manner. The first radio communication network 2 is a wide area network such as a cellular network for mobile phone communication and includes one or more base stations. On the other hand, the second radio communication network 3 is a local network smaller than the first radio communication network 2 in terms of coverage area. For example, the second radio communication network 3 may be a wireless LAN. The second radio communication network 3 includes one or more access points such as an access point 3a. These access points may also be referred to as base stations. The mobile communication apparatus 10 may be, for example, a mobile phone, smart phone, personal digital assistant (PDA), tablet, laptop personal computer (PC), or any other mobile terminal device with multiple radio interfaces.

For example, the mobile communication apparatus performs data communication over the first radio communication network 2 or second radio communication network 3. This data communication may include VoIP calls, i.e., voice communication services using packets to transmit speech data. During a communication session, the mobile communication apparatus 10 may perform a handover from the first radio communication network 2 to the second radio communication network 3 and the other way around. For example, the mobile communication apparatus 10 is capable of switching the communication path from the first radio communication network 2 to the second radio communication network 3 and vice versa, without disrupting the ongoing data communication.

The mobile communication apparatus 10 includes a first radio communication unit 11, a second radio communication unit 12, and a control unit 13. The first radio communication unit 11 is a radio interface that can communicate wirelessly with base stations of the first radio communication network 2. The second radio communication unit 12 is a radio interface that can communicate wirelessly with base stations of the second radio communication network 3. These two radio communication networks 2 and 3 may support different communication protocols from each other.

The control unit 13 controls the above two radio communication units 11 and 12. The control unit 13 may include a central processing unit (CPU), digital signal processor (DSP), or any other processor. The control unit 13 may further include an application-specific integrated circuit (ASIC), field-programmable gate array (FPGA), or other special-purpose electronic circuits. The processor in the control unit 13 executes communication control programs stored in, for example, a random access memory (RAM), flash memory, or any other storage device. The term “processor” may be used to refer to a single processing device or a multiprocessor system including two or more processing devices.

The control unit 13 initially selects the first radio communication network 2 as its communication path. Under the control unit 13, the first radio communication unit 11 starts a communication session 16 over the first radio communication network 2. For example, this session 16 may be a data communication session in VoIP telephony.

The control unit 13 also causes the second radio communication unit 12 to perform a first scan 17 for detecting access points (e.g., access point 3a in FIG. 1) in the second radio communication network 3. The second radio communication unit 12 executes this first scan 17 accordingly and obtains an identifier of a detected access point 3a. The obtained identifier may be, for example, an extended service set identifier (ESSID). During the first scan 17, the second radio communication unit 12 also calculates the level of radio signals received from the access point 3a. For example, signal levels are expressed in the form of received signal strength indicator (RSSI) or the like. The first scan 17 is, for example, a broadcast scan to detect any available access points. That is, there is no restriction about which access points to scan.

When the signal level calculated in the first scan 17 exceeds a first threshold 14, the control unit 13 switches the path for the communication session 16 from the first radio communication network 2 to the second radio communication network 3. In other words, the control unit 13 determines to do a handover from the first radio communication network 2 to the second radio communication network 3. When the signal level calculated in the first scan 17 is equal to or lower than a second threshold 15, the control unit 13 causes the second radio communication unit 12 to repeat more first scans 17. Note that the second threshold 15 is smaller than the first threshold 14.

When the signal level calculated in the first scan 17 is equal to or lower than the first threshold 14, but greater than the second threshold 15, the control unit causes the second radio communication unit 12 to execute a second scan 18. This second scan 18 uses the identifier of the access point 3a detected in the first scan 17 so as to narrow down the scanning range. For example, the second scan 18 is executed as a unicast scan directed to an access point that has the particular identifier noted above. The second scan 18 is lighter than the first scan 17 in its processing load and thus may be executed at shorter intervals. The second radio communication unit 12 executes such second scans 18 under the control of the control unit 13. In the second scans 18, the second radio communication unit 12 detects an access point 3a and calculates the level of signals received from that access point 3a just as in the first scan 17.

The signal level calculated in a second scan 18 may exceed the first threshold 14 discussed above. When this is the case, the control unit 13 switches the path for the communication session 16 from the first radio communication network 2 to the second radio communication network 3. In other words, the control unit 13 determines to do a handover from the first radio communication network 2 to the second radio communication network 3. When a handover is decided as a result of first scans 17 or second scans 18, the first radio communication unit 11 temporarily stops the communication session 16 on the first radio communication network 2, and the second radio communication unit 12 takes over the communication session 16 by establishing a connection with the access point 3a detected in the scans.

In operation of the first embodiment described above, the proposed mobile communication apparatus 10 performs a first scan 17 during a communication session 16 on the first radio communication network 2. This first scan 17 detects an access point 3a and calculates its signal level. If the calculated signal level is equal to or smaller than a first threshold 14, but exceeds a second threshold 15, the mobile communication apparatus 10 conducts a second scan 18 using the identifier of the detected access point 3a. The second scan 18 calculates a signal level again, and if it exceeds the first threshold 14, the path of the communication session 16 is switched from the first radio communication network 2 to the second radio communication network 3.

The use of second scans 18 in combination with first scans 17 alleviates the load of scanning operation and makes it possible to execute second scans 18 at shorter intervals than first scans 17. Even when there are many access points in a reachable distance, the mobile communication apparatus 10 can detect an appropriate access point without the risk of overlooking some of those access points because the second scans 18 focus upon a limited set of access points. The mobile communication apparatus 10 can easily keep track of increasing signal levels from the access point 3a after its detection by the first scan 17 and promptly connect to the access point 3a when the signal level exceeds the first threshold 14.

Accordingly, the proposed mobile communication apparatus 10 does not miss the chance for a connection to the access point 3a of the second radio communication network 3 even if the first threshold 14 is raised. A raised first threshold 14 enables the communication session 16 to keep its quality at a high level even in the transient period after the path switching from the first radio communication network 2 to the second radio communication network 3.

### (b) Second Embodiment

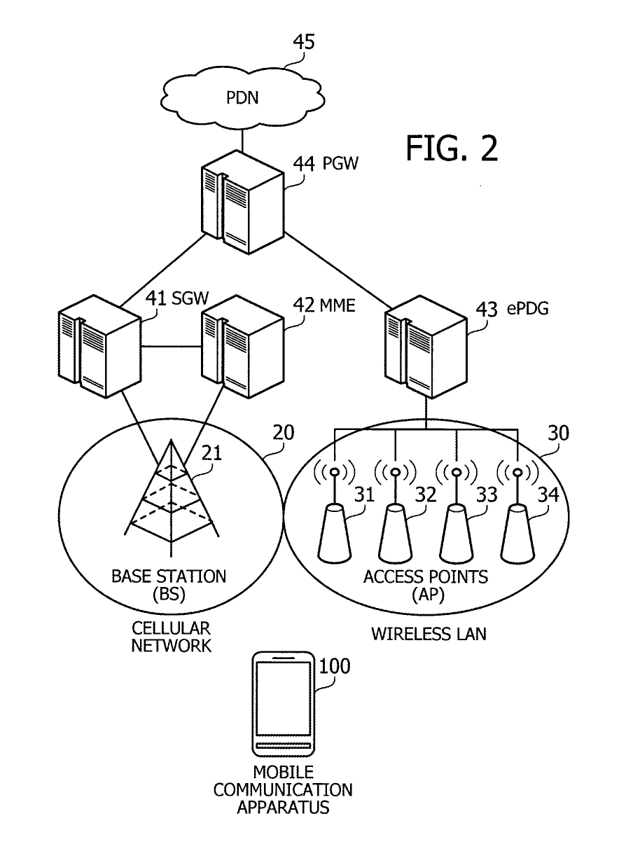

FIG. 2 illustrates a radio communication system according to a second embodiment. The illustrated radio communication system of the second embodiment is formed from a cellular network 20, a wireless LAN 30, a Serving Gateway (SGW) 41, a Mobility Management Entity (MME) 42, an Enhanced Packet Data Gateway (ePDG) 43, a Packet Data Gateway (PGW) 44, a Packet Data Network (PDN) 45, and a mobile communication apparatus 100. The cellular network 20 includes a base station (BS) 21. The wireless LAN 30 includes a plurality of access points (AP) 31 to 34 (referred to as “first access point” to “fourth access point,” where appropriate).

The mobile communication apparatus 100 in FIG. 2 is an example of the mobile communication apparatus 10 discussed in the first embodiment. The cellular network 20 in FIG. 2 is an example of the first radio communication network 2 discussed in the first embodiment. The wireless LAN 30 in FIG. 2 is an example of the second radio communication network 3 discussed in the first embodiment. Each access point 31 to 34 in FIG. 2 is an example of the access point 3a discussed in the first embodiment.

The cellular network 20 has a large radio coverage area containing the area of the wireless LAN 30, although it does not appear to have in FIG. 2. In other words, the base station 21 in the cellular network 20 forms a macrocell. The cellular network 20 complies with, for example, the wideband code division multiple access (W-CDMA) or Long Term Evolution (LTE) standard for wireless communication developed by the 3rd Generation Partnership Project (3GPP).

The base station 21 has a wired network interface for wire-based communication with the SGW 41 and MME 42, in addition to a radio interface for wireless communication with a mobile communication apparatus 100 and others. The base station 21 passes packet data from the mobile communication apparatus 100 to the SGW 41 and the other way around. The base station 21 also exchanges control data with the MME 42 to control radio communication sessions with the mobile communication apparatus 100.

Each access point 31 to 34 of the wireless LAN locally covers a part of the service area of the cellular network 20. In other words, service areas of the wireless LAN 30 are scattered in that of the cellular network 20. The wireless LAN 30 complies with a series of radio communication standards in the Institute of Electrical and Electronics Engineers (IEEE) 802.11 family. The standards include, for example, IEEE 802.11g, IEEE 802.11n, and IEEE 802.11ac. The wireless LAN 30 may be formed from Wi-Fi certified devices.

Each access point 31 to 34 has a wired network interface for wire-based communication with the ePDG 43, in addition to a radio interface for wireless communication with a mobile communication apparatus 100 and the like. The access points 31 to 34 send their packet data from the mobile communication apparatus 100 to the ePDG 43 and the other way around. The access points 31 to 34 may also be referred to as “base stations,” and the base station 21 as an “access point.”

The SGW 41 is a communication device for handling packet data in the cellular network 20. Specifically, the SGW 41 forwards packet data from the PGW 44 to the base station 21, and vice versa. The MME 42 is a communication device that handles control data for the cellular network 20. That is, the MME 42 exchanges control data with the base station 21, as well as with the SGW 41.

The ePDG 43 is a communication device that routes packets from other access networks than the cellular network 20 toward the cellular network 20 or PDN 45. Such outside networks include those that are not authorized to connect without security protection. For example, the ePDG 43 permits access from access points 31 to 34 and forwards packet data from them to the PGW 44 and the other way around.

The PGW 44 is a communication device that serves as a gateway between the PDN 45 and access networks (i.e., cellular network 20 and wireless LAN 30). The PGW 44 forwards packet data from the SGW 41 or ePDG 43 to the PDN and vice versa. The PDN 45 is a data communication network for delivering packet data using the Internet Protocol (IP), for example. Although not seen in FIG. 2, information processing apparatuses may be connected to the PDN 45 to provide various services. Other networks such as the Internet may also be connected to the PDN 45.

The mobile communication apparatus 100 is a portable radio communication device that has two radio interfaces for connection with the cellular network 20 and wireless LAN 30. For example, the mobile communication apparatus 100 may be a mobile phone, smart phone, PDA, tablet, laptop PC, or any other user-operable terminal device.

The mobile communication apparatus 100 makes access to the PDN 45 via the cellular network 20 or wireless LAN 30 and receives various data from the PDN 45, including web pages, still images, and motion videos. The PDN 45 also acts as a SIP server and controls handover processes between the cellular network 20 and wireless LAN 30. This feature of the PDN 45 enables the mobile communication apparatus 100 to transmit and receive voice data using VoIP via the cellular network 20 or wireless LAN 30, enjoying handover capabilities for seamless vocal communication while moving.

The wireless LAN 30 includes a set of access points placed densely by a single provider to cover as large an area as a shopping mall or office. The radio service areas of these access points may partly overlap with each other. This overlap permits the mobile communication apparatus 100 to hand over its ongoing communication session from access point to access point when it is moving in a shopping mall or office building. As opposed to such multiple access points, the wireless LAN 30 may also include a solitary access point that only covers a relatively small area such as the user's home or small store. Usually no handover takes place between such a stand-along access point and another access point in its surroundings.

It is assumed that the mobile communication apparatus 100 has no previous knowledge about the presence of a handover environment (HO environment) around the current access point. In other words, the mobile communication apparatus 100 is initially unaware of whether there are access points potentially available for handover. As will be described later, the mobile communication apparatus 100 is designed to estimate the presence or absence of a handover environment on the basis of its current detection of access points. The second embodiment assumes that at least two access point 31 and 32 belong to one handover environment.

Each access point is given a basic service set identifier (BSSID) and an ESSID as its individual identifiers. BSSID is a numerical value with a length of 48 bits for the purpose of physical distinctions between individual access points. Usually, the medium access control (MAC) address of an access point also serves as its BSSID. ESSID, on the other hand, is an alpha numeric string with a length of 32 characters for the purpose of logical distinctions between different sets of access points. For example, the service provider may assign the same ESSID to a plurality of access points that belong to their wireless LAN service.

Fourteen channels are available in 2.4-GHz band, and nineteen channels in 5-GHz band. Each access point uses at least one of these channels for radio communication. The illustrated four access points 31 to 34 have their shared ESSID, namely “ESSID 00,” assigned by the service provider. On the other hand, these access points 31 to 34 have different BSSIDs and use different communication channels. Specifically, the first access point 31 has “BSSID 01” and uses channel CH1. The second access point 32 has “BSSID 02” and uses channel CH6. The third access point 33 has “BSSID 03” and uses channel CH11. The fourth access point 34 has “BSSID 04” and uses channel CH44.

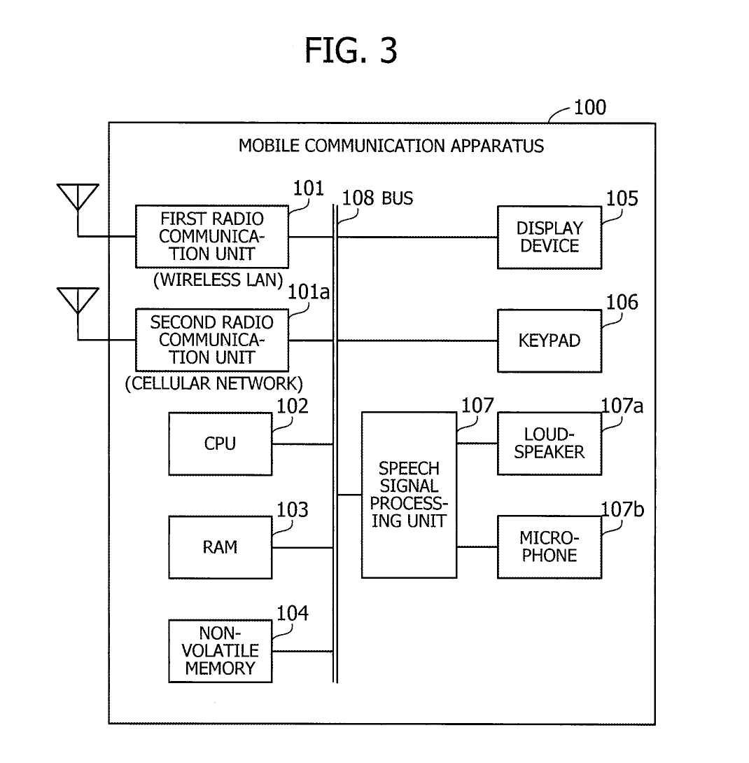

FIG. 3 is a block diagram illustrating an exemplary hardware configuration of a mobile communication apparatus. The illustrated mobile communication apparatus 100 includes two radio communication units 101 and 101a (referred to as “first radio communication unit” and “second radio communication unit,” where appropriate), a CPU 102, a RAM 103, a non-volatile memory 104, a display device 105, a keypad 106, a speech signal processing unit 107, a loudspeaker 107a and a microphone 107b. The loudspeaker 107a and microphone 107b are connected to the speech signal processing unit 107. The first and second radio communication units 101 and 101a, CPU 102, RAM 103, non-volatile memory 104, display device 105, keypad 106, and speech signal processing unit 107 are connected to a bus 108.

The first radio communication unit 101 is an example of the second radio communication unit 12 discussed in the first embodiment. The second radio communication unit 101a is an example of the first radio communication unit 11 discussed in the first embodiment. The CPU 102 is an example of the control unit 13 discussed in the first embodiment.

The first radio communication unit 101 is a radio interface that support communication protocols of the wireless LAN 30. The first radio communication unit 101 scans access points according to commands from the CPU 102 and returns its result to the CPU 102. In this course, the first radio communication unit 101 measures the level of a signal received from each detected access point. The second embodiment uses RSSI as the signal level indicator. The scanning result may include BSSID, ESSID, channel number, and RSSI of each detected access point. The first radio communication unit 101 also performs some protocol sequences for connecting to an access point specified by the CPU 102 or disconnecting from the same.

The second radio communication unit 101a is a radio interface that support communication protocols of the cellular network 20. The second radio communication unit 101a may set up a connection to the base station 21 according to commands from the CPU 102 and conduct data communication via the base station 21.

The CPU 102 is a processor that executes programs. More specifically, the CPU 102 loads the RAM 103 with at least some programs and data read out of the non-volatile memory 104 and executes processing operations as encoded in these programs. The CPU 102 may include a plurality of processor cores, and the mobile communication apparatus 100 may include two or more processors. These processors or processor cores may be used to execute multiple processing operations (described later) in parallel. The term “processor” may be used to refer to a single processing device or a multiprocessor system including two or more processing devices.

The RAM 103 is a volatile semiconductor memory device that temporarily stores programs that the CPU 102 executes, as well as various data objects that the CPU 102 manipulates in the course of computation. Other type of memory devices may be used in place of or together with the RAM 103, and the mobile communication apparatus 100 may have two or more sets of such memory devices.

The non-volatile memory 104 serves as a non-volatile storage device to store program and data of the operating system (OS), middleware, applications, and other kinds of software. A communication control program for radio communication control is one of the stored programs. The non-volatile memory 104 may be, for example, flash memory devices. The mobile communication apparatus 100 may include a plurality of non-volatile storage devices such as solid state drives (SSD) and hard disk drive (HDD) in place of or together with the illustrated non-volatile memory 104.

The display device 105 outputs operation screens according to commands from the CPU 102, in addition to web pages, still images, motion videos, and other content. The display device 105 may be a liquid crystal display (LCD), organic electro-luminescence (OEL) display, or the like.

The keypad 106 is an input device for the user to enter his or her commands and the like. The keypad 106 includes one or more keys that produce signals for input to the CPU 102 when the user presses them. The mobile communication apparatus 100 may have some other input device such as a touchscreen, in place of or together with the keypad 106. For example, a touchscreen may be layered on top of the display device 105. The touchscreen detects the user's fingertip touches on the display device 105 and supplies the CPU 102 with the touched positions.

The speech signal processing unit 107 processes speech signals according to commands from the CPU 102. That is, the speech signal processing unit 107 receives digital voice data, converts it into analogue speech signals, and outputs them to the loudspeaker 107a. The speech signal processing unit 107 also captures analog speech signals from the microphone 107b and coverts them into digital voice data.

The loudspeaker 107a is an electroacoustic transducer that reproduces sound (physical vibrations) from electrical speech signals provided from the speech signal processing unit 107. For example, the loudspeaker 107a reproduces the voice of a person, together with background noise, in a distant location when the user is engaged in a phone call. The microphone 107b is an acoustoelectric transducer that converts physical sound vibrations into electrical form and provides the resulting electrical speech signals to the speech signal processing unit 107. For example, the microphone 107b captures the voice of the user and background noise when the user is engaged in a phone call.

The description will now explain how the proposed mobile communication apparatus 100 scans available access points. The mobile communication apparatus 100 is capable of switching its communication path from cellular network 20 to wireless LAN 30, while continuing a voice call of VoIP. It can also switch the path from wireless LAN 30 to cellular network 20 while continuing a voice call of VoIP. If the ongoing call was handed over from the current base station 21 to a LAN access point in spite of a small RSSI of the access point, the quality of voice communication would immediately drop upon handover. The call may reversely be handed over from the current access point to the base station 21 after the RSSI of the access point falls sufficiently. In this case, the user would experience a low voice quality before the handover takes place.

In view of the above, the mobile communication apparatus 100 ensures the stability of voice quality by selecting a higher threshold for RSSI and using this raised RSSI threshold in determining whether to trigger a handover between the base station 21 and access points 31 to 34. Accordingly, the mobile communication apparatus 100 does not start a handover from the base station 21 until the RSSI of a new access point reaches a sufficiently high level. The mobile communication apparatus 100 also performs an earlier handover to the base station 21 while the current access point has a large RSSI. The raised threshold, on the other hand, would spoil the ability of detecting access points. The proposed mobile communication apparatus 100 thus performs several types of scans described below to alleviate the difficulty in connecting to access points 31 to 34.

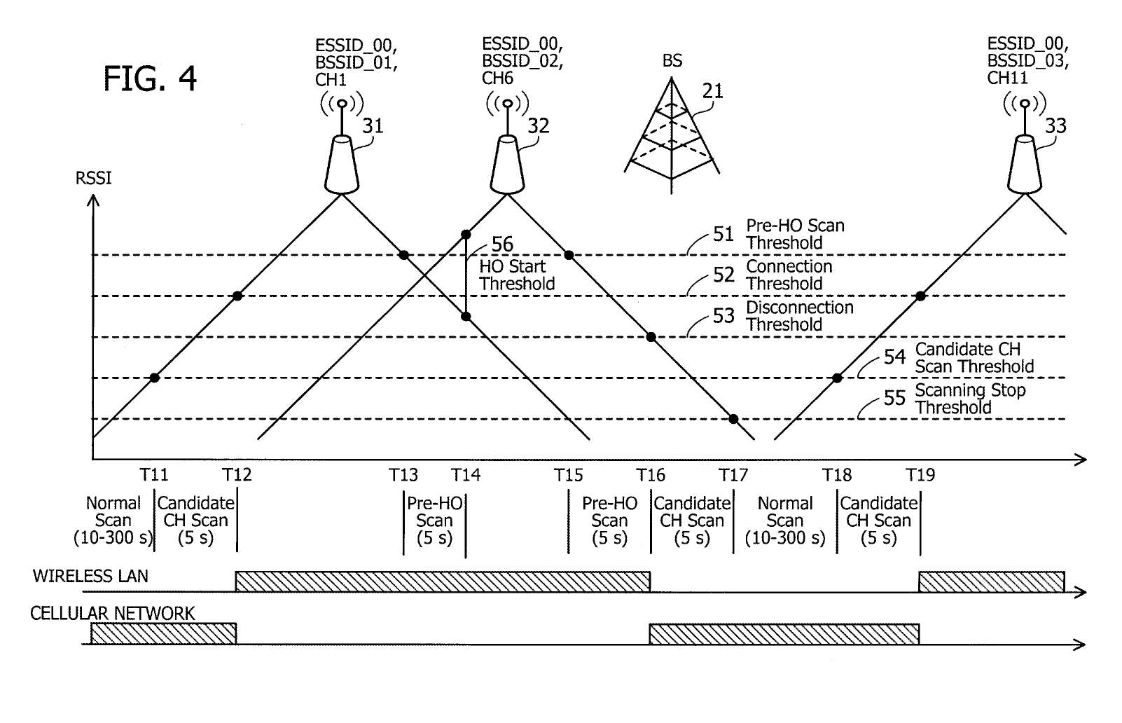

FIG. 4 illustrates an example of access point connection in a handover environment. To detect access points of the wireless LAN 30, the mobile communication apparatus 100 has the following three scanning options: (a) normal scan, (b) candidate channel scan, and (c) pre-handover scan. Where appropriate, the short form “candidate CH scan” may be used for candidate channel scan, and “pre-HO scan” for pre-handover scan.

Normal scans investigate all 32 channels in seeking access points, regardless of ESSID (i.e., no particular ESSID is specified). Normal scans may be repetitively executed, and in that case, their intervals are successively increased, as in 10 seconds, 20 seconds, seconds, 120 seconds, and 300 seconds. Once the interval reaches 300 seconds, the mobile communication apparatus 100 keeps that interval for subsequent iterations of normal scan. Candidate channel scans similarly investigate all 32 channels in seeking access points, but with a specified ESSID. The mobile communication apparatus 100 may repeat candidate channel scans at five-second intervals, for example. Pre-handover scans investigate some specified channels to keep track of access points with a specified ESSID. The mobile communication apparatus 100 may repeat pre-handover scans at five-second intervals, for example.

Suppose now that the mobile communication apparatus 100 is currently doing a VoIP call session via the cellular network 20. The mobile communication apparatus 100 performs normal scans for the wireless LAN 30 while communicating data to and from the base station 21. One normal scan then finds a signal from a first access point 31. If RSSI of this first access point 31 exceeds a candidate channel scan threshold 54 (T11), the mobile communication apparatus 100 then starts candidate channel scans, still continuing data communication with the base station 21. These candidate channel scans specify “ESSID_00,” the ESSID of the detected first access point 31. In other words, the mobile communication apparatus 100 watches RSSI of a limited set of access points with “ESSID_00.”

The measured RSSI of the first access point 31 then exceeds a connection threshold 52 (T12) during the candidate channel scans. Upon detection, the mobile communication apparatus 100 hands over its data communication from the base station 21 to the first access point 31. The immediately previous candidate channel scan may have detected a plurality of access points with “ESSID_00.” If that is the case, the mobile communication apparatus 100 recognizes that it is currently in a handover environment. In the illustrated example, the mobile communication apparatus 100 finds a handover environment that has two access points 31 and 32.

When the RSSI of the first access point 31 falls below a pre-handover scan threshold 51 in the current handover environment (T13), the mobile communication apparatus 100 begins pre-handover scans while performing data communication with the first access point 31. These pre-handover scans specify “ESSID_00,” the ESSID of the first access point 31. They also specify particular channels CH1 and CH6 in which the preceding candidate channel scans have found access points. In other words, the mobile communication apparatus 100 watches RSSIs in limited channels and with a limited ESSID.

The mobile communication apparatus 100 now keeps track of the difference in RSSI of the second access point 32 from the first access point 31. When the difference is positive and exceeds a handover (HO) start threshold 56 (T14), the mobile communication apparatus 100 hands its data communication over to the second access point 32. RSSI of the second access point 32 then falls to or below the pre-handover scan threshold 51 in the handover environment (T15). Then the mobile communication apparatus 100 begins pre-handover scans while continuing data communication with the second access point 32. These pre-handover scans specify “ESSID_00,” the ESSID of the second access point 32. These pre-handover scans also specify particular channels CH1 and CH6 in which the preceding candidate channel scans have found access points.

When RSSI of the second access point 32 further falls to or below a disconnection threshold 53 (T16), the mobile communication apparatus 100 hands over its data communication from the second access point 32 to the base station 21. The mobile communication apparatus 100 now begins candidate channel scans. These candidate channel scans specify “ESSID_00,” the ESSID of the second access point 32 that the mobile communication apparatus 100 has just left in the handover. In other words, the mobile communication apparatus 100 watches RSSIs of a limited set of access points with “ESSID_00.”

The measured RSSI of the second access point 32 further drops to or below a scanning stop threshold 55 (T17) during the candidate channel scans. Upon detection of this drop, the mobile communication apparatus 100 changes the scanning method from candidate channel scan to normal scan. That is, the mobile communication apparatus 100 determines that it has possibly moved out of the handover environment of the wireless LAN and thus begins ESSID-free normal scans. As another possible scenario, the above candidate channel scans may detect an access point that has ESSID_00 and whose RSSI exceeds the connection threshold 52. If this is the case, the mobile communication apparatus 100 performs a handover from the base station 21 to the detected access point. This new access point may possibly be the second access point 32 again.

Referring back to the example of FIG. 4, the normal scans detect a third access point 33, and its RSSI grows over the candidate channel scan threshold 54 (T18). The mobile communication apparatus 100 then begins candidate channel scans while continuing data communication with the base station 21. These candidate channel scans specify “ESSID_00,” the ESSID of the detected third access point 33.

The measured RSSI of the third access point 33 further grows during candidate channel scans and exceeds the connection threshold 52 (T19). The mobile communication apparatus 100 then hands over its data communication from the base station 21 to the third access point 33. As another possible scenario, the preceding normal scans or candidate channel scans may find the second access point 32 again. In that case, the mobile communication apparatus 100 hands over its data communication to the second access point 32.

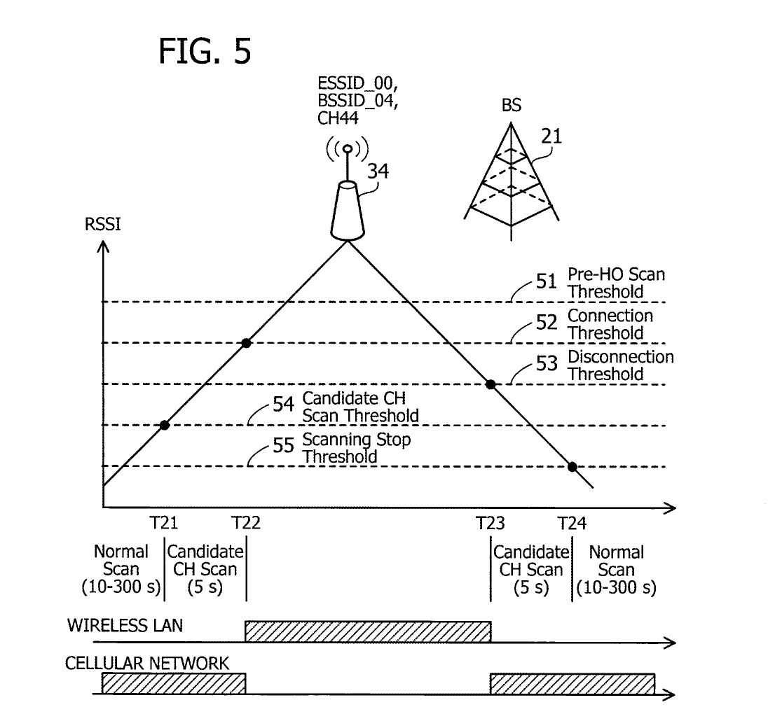

FIG. 5 illustrates an example of access point connection in a single AP environment. It is assumed here that the mobile communication apparatus 100 is currently doing a VoIP call session via the cellular network 20, just as in the situation of FIG. 4. The mobile communication apparatus 100 performs normal scans while communicating data to and from the base station 21. The normal scans now detect a fourth access point 34, and its RSSI grows over the candidate channel scan threshold 54 (T21). The mobile communication apparatus 100 then begins candidate channel scans while continuing data communication with the base station 21. These candidate channel scans specify “ESSID_00,” the ESSID of the detected fourth access point 34.

RSSI of the fourth access point 34 further grows during the candidate channel scans and exceeds the connection threshold 52 (T22). The mobile communication apparatus 100 then hands over its data communication from the base station 21 to the fourth access point 34. At this moment, the mobile communication apparatus 100 determines whether the latest candidate channel scan has detected a plurality of access points with “ESSID_00.” If it is only one access point, the mobile communication apparatus 100 determines that it is currently in a single AP environment, meaning that there are no other surrounding access points to hand over the current communication (i.e., absence of handover environment). What is detected in the example of FIG. 5 is a single access point 34, and the mobile communication apparatus 100 thus finds itself in a single AP environment.

The mobile communication apparatus 100 in a single AP environment does not execute pre-handover scans even though the fourth access point 34 exhibits a drop of RSSI to or below the pre-handover scan threshold 51. This is because of small possibilities for pre-handover scans to detect other access points for handover. When RSSI of the fourth access point 34 drops to or below the disconnection threshold 53 (T23), the mobile communication apparatus 100 hands over its data communication from the fourth access point 34 to the base station 21 and starts candidate channel scans. These candidate channel scans specify “ESSID_00,” the ESSID of the fourth access point that the mobile communication apparatus 100 has just left.

The measured RSSI of the fourth access point 34 further drops to or below a scanning stop threshold 55 (T24) during the candidate channel scans. Upon detection of this drop, the mobile communication apparatus 100 changes the scanning method from candidate channel scan to normal scan. In the case where the measured RSSI exhibits a rise that exceeds the connection threshold 52, the mobile communication apparatus 100 performs another handover from the base station 21 to the fourth access point 34.

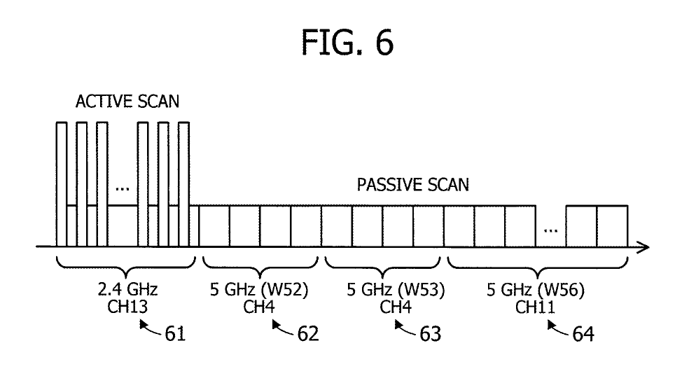

FIG. 6 illustrates an example of wireless LAN channels. The foregoing access points 31 to 34 in the wireless LAN 30 are allowed to use at least one of the illustrated frequency bands 61 to 64. The leftmost frequency band 61 in FIG. 6 belongs to 2.4-GHz band and includes thirteen channels, CH1 to CH13. The next frequency band 62 ranges from 5.15 GHz to 5.25 GHz (W52) in 5-GHz band, and includes four channels, CH36, CH40, CH44, and CH48. The next frequency band 63 ranges from 5.25 GHz to 5.35 GHz (W53) in 5-GHz band and includes four channels, CH52, CH56, CH60, and CH64. The rightmost frequency band 64 in FIG. 6 ranges from 5.47 GHz to 5.725 GHz (W56) in 5-GHz band and includes eleven channels, CH100, CH104, CH108, CH112, CH116, CH120, CH124, CH128, CH132, CH136, and CH140.

In the 2.4-GHz frequency band 61, the mobile communication apparatus 100 performs active scans, which may take the form of broadcast scans or unicast scans. More specifically, a broadcast scan transmits a probe request with no ESSID. Upon receipt of a probe request, access points return probe responses each containing their individual BSSID and ESSID. A unicast scan transmits a probe request with a specific ESSID. Access points return probe responses each containing their individual BSSID and ESSID only when their own ESSID matches with the ESSID specified in the probe request. The turnaround time of transmission of a probe request and reception of a probe response is about 30 milliseconds (ms) per channel.

In the other frequency bands 62 to 64, the mobile communication apparatus 100 basically performs passive scans. Specifically, the mobile communication apparatus 100 seeks control signals called “beacon” from access points. Each access point broadcasts its own beacon at a specific intervals (e.g., 102.4 ms). A beacon carries BSSID and ESSID of an access point, thus delivering information equivalent to a probe response in the active scan scheme. Detection of beacon signals takes a time of about 120 ms per channel.

In normal scans, the mobile communication apparatus 100 conducts broadcast scans in all thirteen channels of the frequency band 61, while performing passive scans in all nineteen channels of other frequency bands 62 to 64. In candidate channel scans, the mobile communication apparatus 100 conducts unicast scans in all thirteen channels of the frequency band 61, while performing passive scans in all nineteen channels of other frequency bands 62 to 64.

In contrast to the above, pre-handover scans operate with a limited number of channels. That is, the mobile communication apparatus 100 conducts unicast scans in one or more specific candidate channels out of the thirteen channels of the frequency band 61, and passive scans in one or more specific candidate channels out of the nineteen channels of frequency bands 62 to 64. The mobile communication apparatus 100 is unable to perform pre-handover scans concurrently with data communication over the wireless LAN 30. For this reason, an interval of 500 ms is taken before moving from one channel to another. That is, the mobile communication apparatus 100 minimizes continuous stoppage of data communication, thereby avoiding quality degradation of VoIP calls during pre-handover scans.

Note that the scans in 5-GHz bands are not active scans, but passive scans because of the presence of legal regulations that limit outdoor signal transmission in those frequency bands. The mobile communication apparatus 100 may, however, be configured to perform active scans in 5-GHz bands when the current location is estimated to be indoor (e.g., when W52 or W53 radio signals are received).

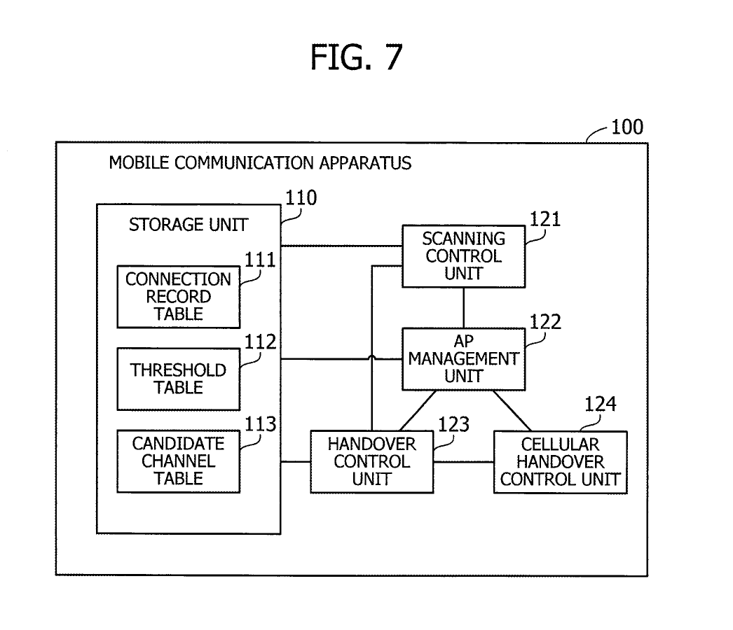

The description now turns to the functions implemented in the mobile communication apparatus 100. FIG. 7 is a block diagram illustrating exemplary functions of a mobile communication apparatus. The illustrated mobile communication apparatus 100 includes a storage unit 110, a scanning control unit 121, an AP management unit 122, a handover control unit 123, and a cellular handover control unit 124. Here, the storage unit 110 may be implemented by using a storage space of the RAM 103 or non-volatile memory 104. The scanning control unit 121, AP management unit 122, handover control unit 123, and cellular handover control unit 124 may be implemented as program modules that the CPU 102 executes.

The storage unit 110 stores therein a set of control data for scanning access points and controlling connections to access points. This control data includes a connection record table 111, a threshold table 112, and a candidate channel table 113.

The connection record table 111 records ESSID of each access point that the mobile communication apparatus 100 connected in the past according to user commands. The threshold table 112 stores various thresholds, including the foregoing pre-handover scan threshold 51 and connection threshold 52. These thresholds may be determined previously, as part of the manufacturing or shipping process of the mobile communication apparatus 100. The thresholds may further be updated after shipment of the mobile communication apparatus 100, as necessitated by software version changes. The candidate channel table 113 contains records of the channels in which access points are found as a result of candidate channel scans.

The scanning control unit 121 commands the first radio communication unit 101 (FIG. 3) to execute scans and receives the scanning result from the same. In this course, the scanning control unit 121 may specify ESSIDs and channels to the first radio communication unit 101, depending on the type of scans. The scanning control unit 121 may also specify a threshold of RSSI as the reference level for access point detection. The received scanning result is transferred from the scanning control unit 121 to either the AP management unit 122 or the handover control unit 123, depending on the type of the conducted scans. Specifically, the scanning result includes BSSID, ESSID, channel number, and RSSI of each detected access point.

Normal scans restrict neither ESSIDs nor channels, and the scanning control unit 121 transfers their result information from the first radio communication unit 101 to the AP management unit 122. Candidate channel scans restrict ESSIDs, but not channels. The reference level (i.e., threshold) for access point detection in candidate channel scans is smaller than that in normal scans. The result of candidate channel scans is transferred to the AP management unit 122. Pre-handover scans restrict not only ESSIDs, but channels as well, and their result is transferred to the handover control unit 123.

The AP management unit 122 manages selection of an access point, connection to the selected access point, disconnection from the current access point, and the like. Upon receipt of a normal scanning result from the scanning control unit 121, the AP management unit 122 determines whether the detected ESSID is registered in the connection record table 111, as well as whether the detected RSSI exceeds a candidate channel scan threshold 54. If the access point in question satisfies both of these conditions, the AP management unit 122 then commands the scanning control unit 121 to perform candidate channel scans with the specific ESSID.

Upon receipt of a candidate channel scanning result from the scanning control unit 121, the AP management unit 122 determines whether the detected RSSI exceeds a connection threshold 52. If the access point in question satisfies this condition, the AP management unit 122 then commands the cellular handover control unit 124 to stop its packet communication over the cellular network and causes the first radio communication unit 101 to execute a connection procedure. The AP management unit 122 further examines the candidate channel scanning result to determine whether the current location is a handover environment or a single AP environment. More specifically, the current location is found to be a handover environment when there are two or more access points with the same ESSID. The AP management unit 122 then updates the candidate channel table 113 accordingly. The AP management unit 122 may also cause the first radio communication unit 101 to execute a disconnection procedure when so requested by the handover control unit 123.

The handover control unit 123 controls handover operations from one access point to another access point of the wireless LAN 30. For example, the current access point may exhibit a decreased RSSI that falls below a pre-handover scan threshold 51. The handover control unit 123 obtains this information from the scanning control unit 121 and then commands the scanning control unit 121 to begin pre-handover scans.

The scanning control unit 121 provides the handover control unit 123 with a pre-handover scanning result. In response, the handover control unit 123 determines whether there is any other access point that exhibits a sufficiently large RSSI. If such an access point is found, the handover control unit 123 commands the first radio communication unit 101 to perform a handover to that access point (i.e., disconnect from the current access point and establish a connection to the new access point).

As another example, the current access point may exhibit a reduction in RSSI that falls below a disconnection threshold 53. The handover control unit 123 then commands the AP management unit 122 to disconnect from the access point, while requesting the cellular handover control unit 124 to resume packet communication over the cellular network 20.

The cellular handover control unit 124 controls handover operations between the cellular network 20 and wireless LAN 30. Specifically, the cellular handover control unit 124 causes the second radio communication unit 101a to stop transmission and reception of packets when so requested by the AP management unit 122. The cellular handover control unit 124 also causes the second radio communication unit 101a to resume transmission and reception of packets when so requested by the handover control unit 123.

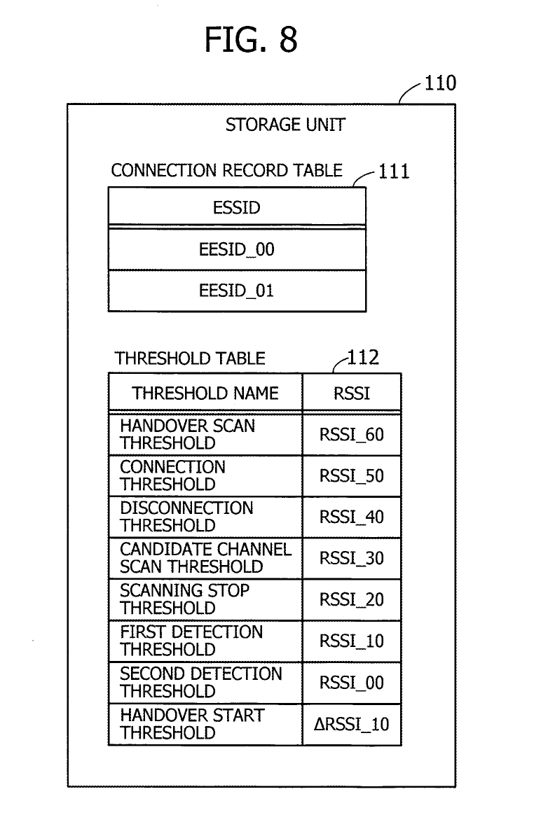

FIG. 8 illustrates an example of a connection record table and a threshold table. The illustrated connection record table 111 resides in the storage unit 110. This connection record table 111 includes a list of ESSIDs representing access points to which the mobile communication apparatus 100 connected in the past according to user commands. The mobile communication apparatus 100 is capable of automatically connecting to an access point, without the need for explicit user commands, if that access point of interest has the same ESSID as an access point that the user specified in the past. Referring to the example of FIG. 8, the illustrated connection record table 111 contains “ESSID_00” and “ESSID_01” as its registered entries. The connection record table 111 may be given beforehand a reliable set of ESSIDs.

The threshold table 112 also resides in the storage unit 110 and includes a plurality of combinations of a threshold name and an RSSI value. Specifically, these thresholds include, among others, the foregoing pre-handover scan threshold 51, connection threshold 52, disconnection threshold 53, candidate channel scan threshold 54, scanning stop threshold 55, and handover start threshold 56. Also included in the threshold table 112 are a first detection threshold and a second detection threshold.

The pre-handover scan threshold 51 is an RSSI threshold for determining whether to start pre-handover scans. It is set to, for example, −55 dBm. The connection threshold 52 is an RSSI threshold for determining whether to make a connection to an access point of the wireless LAN 30, and it is set to, for example, −60 dBm. The connection threshold 52 may also serve as an RSSI threshold for determining whether to trigger a handover from the cellular network 20 to the wireless LAN 30. The disconnection threshold 53 is an RSSI threshold for determining whether to disconnect from an access point of the wireless LAN 30, and it is set to, for example, −70 dBm. This disconnection threshold 53 may also serve as an RSSI threshold for determining whether to trigger a handover from the wireless LAN 30 to the cellular network 20.

The candidate channel scan threshold 54 is an RSSI threshold for determining whether to initiate candidate channel scans, and it is set to, for example, 80 dBm. The scanning stop threshold 55 is an RSSI threshold for determining whether to stop candidate channel scans, and it is set to, for example, −85 dBm. The first detection threshold is an RSSI threshold that the first radio communication unit 101 uses as the reference level for detecting access points in normal scans and pre-handover scans. For example, it is set to −85 dBm. The result of a normal scan and pre-handover scan contains information about access points whose respective RSSIs exceed the first detection threshold.

The second detection threshold is an RSSI threshold that the first radio communication unit 101 uses as the reference level for detecting access points in candidate channel scans. For example, it is set to −90 dBm. The result of a candidate channel scan contains information about access points whose respective RSSIs exceed the second detection threshold. The handover start threshold 56 is a threshold of RSSI differences for determining whether to start a handover between access points of the wireless LAN 30. It is set to, for example, 10 dBm.

The pre-handover scan threshold 51 is larger than the connection threshold 52. The connection threshold is larger than the disconnection threshold 53. The disconnection threshold 53 is larger than or equal to the candidate channel scan threshold 54. The candidate channel scan threshold 54 is larger than the scanning stop threshold 55. The scanning stop threshold 55 is larger than or equal to the first detection threshold. The first detection threshold is larger than the second detection threshold.

The rest of this description may use a special notation to express RSSI levels. That is, RSSI_nn is a combination of the symbol “RSSI_” and a two-digit number “nn,” to represent the magnitude of RSSI. The greater the number, the larger the RSSI level. Referring to the example seen in FIG. 8, the pre-handover scan threshold 51 has a value of RSSI_60, and the connection threshold 52 has a value of RSSI_50. Similarly, the disconnection threshold 53 has a value of RSSI_40, the candidate channel scan threshold 54 has a value of RSSI_30, and the scanning stop threshold 55 has a value of RSSI_20. The first detection threshold has a value of RSSI_10, and the second detection threshold has a value of RSSI_00. The handover start threshold 56 has a value of ΔRSSI_10, where Δ indicates that the threshold applies to the difference in RSSI between two access points.

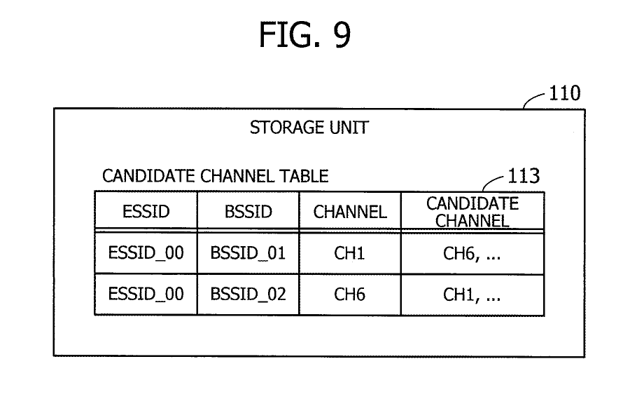

FIG. 9 illustrates an example of a candidate channel table. This candidate channel table 113 resides in the storage unit 110. The candidate channel table 113 is formed from four data fields named as follows: “ESSID,” “BSSID,” “Channel,” and “Candidate channel.” The ESSID and BSSID fields respectively contain ESSID and BSSID of an access point. The channel field contains a channel number representing a channel that the corresponding access point uses. The candidate channel fields contains one or more channel numbers of other access points that were detected in candidate channel scans performed at the same place where the noted access point was detected.

Suppose, for example, that one candidate channel scan has detected two access points 31 and 32 in radio channels CH1 and CH6, respectively. In this case, the candidate channel table 113 is populated with an entry that describes the first access point 31 as having “ESSID_00” and “BSSID_01” in the ESSID and BSSID fields. The channel field contains “CH1” while the candidate channel field contains “CH6” for this entry. In addition, the candidate channel table 113 is populated with another entry that describes the second access point 32 as having “ESSID_00” and “BSSID_02” in the ESSID and BSSID fields. The channel field contains “CH6” while the candidate channel contains “CH1” for this entry.

The description now turns to several typical sequences of handover. The first three handover sequences correspond to the handover environment discussed in FIG. 4, and the subsequent two handover sequences correspond to the single AP environment discussed in FIG. 5.

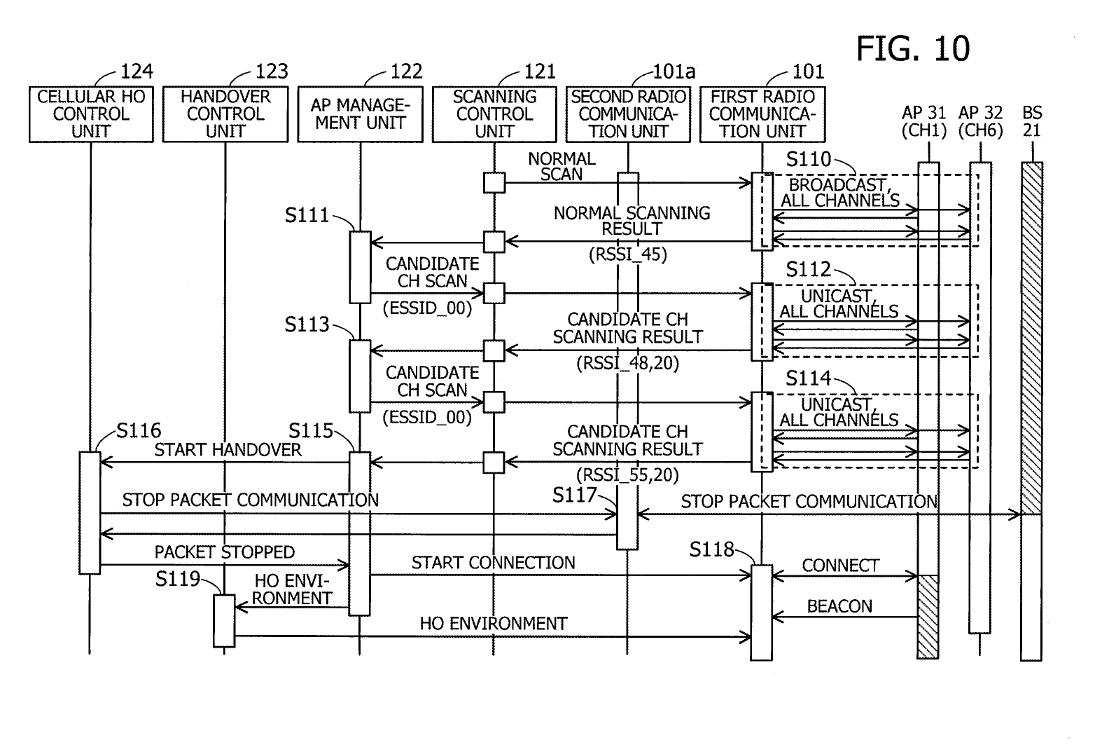

FIG. 10 is a first sequence diagram illustrating an example of communication in a handover environment. It is assumed in this example that the mobile communication apparatus 100 is moving toward the first access point 31 while continuing data communication with the base station 21. The PDN 45 knows that the mobile communication apparatus 100 is currently connected to the cellular network 20. The following description assumes that the mobile communication apparatus 100 registers and updates such connection information in the PDN 45 when it connects itself to either the cellular network 20 or the wireless LAN 30.

In the case where the wireless LAN function of the mobile communication apparatus 100 has been enabled by its user, the scanning control unit 121 requests the first radio communication unit 101 to conduct normal scans, and the first radio communication unit 101 scans all channels accordingly. More specifically, 2.4-GHz band is scanned with the broadcast scan scheme, without specifying any particular ESSID. The first radio communication unit 101 transmits a probe request in channel CH1 and receives a probe response from the first access point 31. The first radio communication unit 101 also transmits a probe request in channel CH6 and receives a probe response from the second access point 32 (S110).

Suppose here that the first access point 31 exhibits its RSSI with a magnitude of RSSI_45. Since this RSSI exceeds the first detection threshold, the first radio communication unit 101 extracts the first access point 31 and sends a normal scanning result to the scanning control unit 121, including the information about the extracted access point 31. The first radio communication unit 101 may go straight to a connection setup procedure in the case where the broadcast scans have detected an access point whose RSSI exceed the connection threshold 52.

The scanning control unit 121 forwards the normal scanning result to the AP management unit 122. The AP management unit 122 recognizes that the ESSID of the first access point 31 is recorded in the connection record table 111, and that its RSSI exceeds the candidate channel scan threshold 54. Accordingly the AP management unit 122 requests the scanning control unit 121 to start candidate channel scans with “ESSID_00” of the first access point 31 (S111).

The scanning control unit 121 causes the first radio communication unit 101 to execute candidate channel scans, while reducing the RSSI threshold from the first detection threshold to the second detection threshold. Specifically, the first radio communication unit 101 scans every channel, with the specified “ESSID_00.” The 2.4-GHz band is unicast-scanned with “ESSID_00.” The first radio communication unit 101 transmits a probe request in channel CH1 and receives a probe response from the first access point 31. The first radio communication unit 101 also transmits a probe request in channel CH6 and receives a probe response from the second access point 32 (S112).

Suppose here that the first access point 31 exhibits RSSI_48 and the second access point 32 RSSI_20. Since both RSSIs exceed the second detection threshold, the first radio communication unit 101 extracts the first access point 31 and second access points 32 and sends this candidate channel scanning result to the scanning control unit 121.

The scanning control unit 121 forwards the candidate channel scanning result to the AP management unit 122. Since the candidate channel scans have discovered multiple access points, the AP management unit 122 determines that the mobile communication apparatus 100 currently resides in a handover environment, and it updates the candidate channel table 113 accordingly. That is, the AP management unit 122 registers the first and second access points 31 and 32 in the candidate channel table 113. The AP management unit 122 also adds channel CH6 into the candidate channel field for the first access point 31, as well as channel CH1 into the candidate channel field for the second access point 32. These updates to the candidate channel field mean that the two access points 31 and 32 are associated with each other via their channels CH1 and CH6.

In addition to the above, the AP management unit 122 recognizes that RSSI of the first access point 31 exceeds the candidate channel scan threshold 54, but not the connection threshold 52. Accordingly, the AP management unit 122 requests the scanning control unit 121 to execute candidate channel scans again, with “ESSID_00” of the first access point 31 (S113).

The scanning control unit 121 causes the first radio communication unit 101 to execute candidate channel scans. In response, the first radio communication unit 101 scans every channel, with the specified “ESSID_00” (S114). Suppose here that the first access point 31 exhibits RSSI_55 while the second access point 32 exhibits RSSI_20. The first radio communication unit 101 informs the scanning control unit 121 of this candidate channel scanning result.

The scanning control unit 121 forwards the candidate channel scanning result to the AP management unit 122. Since the candidate channel scans have found multiple access points, the AP management unit 122 determines that the mobile communication apparatus 100 currently resides in a handover environment. The AP management unit 122 also recognizes that RSSI of the first access point 31 has exceeded the connection threshold 52. Accordingly, the AP management unit 122 determines to connect to the first access point 31, thus requesting the cellular handover control unit 124 to initiate a handover procedure (S115).

The cellular handover control unit 124 requests the second radio communication unit 101a to stop packet communication (S116). The second radio communication unit 101a stops transmission and reception of packets to and from the base station 21 and notifies the cellular handover control unit 124 of the completion of its request (S117). The cellular handover control unit 124 informs the AP management unit 122 that the packet communication is stopped. The AP management unit 122 now supplies BSSID, ESSID, channel number of the new access point 31 to the first radio communication unit 101, thus requesting to start connection.

The first radio communication unit 101 executes a connection procedure using channel CH1, thereby establishing a connection to the first access point 31. Upon completion of connection establishment, the first radio communication unit 101 changes session information in the PDN 45 via the first access point 31, ePDG 43, and PWG 44. The first radio communication unit 101 also receives beacon signals that the first access point 31 transmits periodically (e.g., at regular intervals of about 100 ms). When it is in the middle of exchanging voice packets, the first radio communication unit 101 resumes packet communication (S118). The AP management unit 122 notifies the handover control unit 123 that the mobile communication apparatus 100 currently resides in a handover environment. In response, the handover control unit 123 starts its control operations for handover and notifies the first radio communication unit 101 of the handover environment (S119).

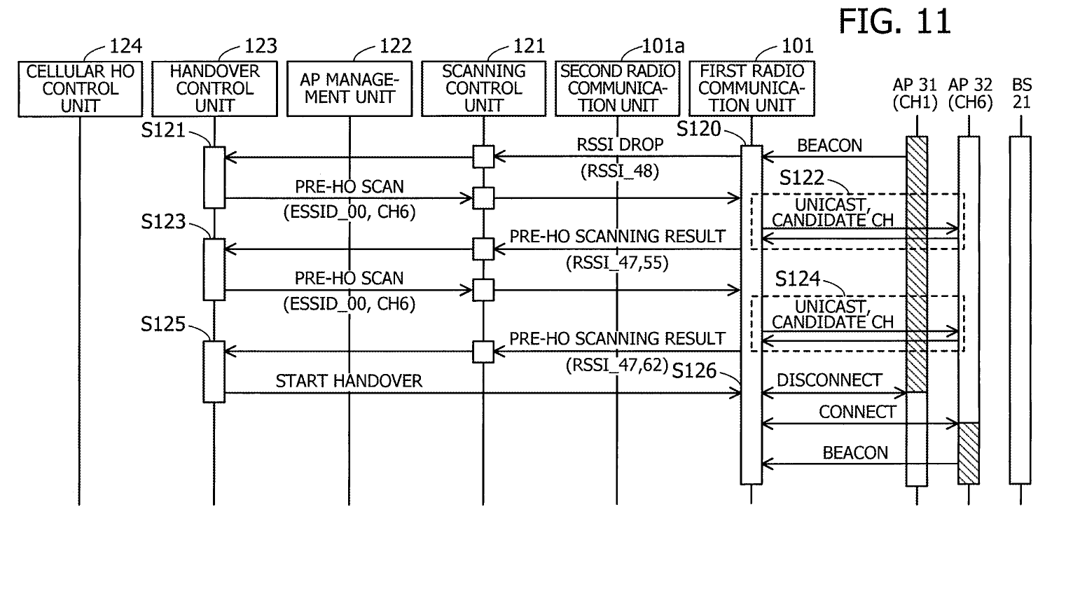

FIG. 11 is a second sequence diagram illustrating another example of communication in a handover environment. It is assumed in this example that the mobile communication apparatus 100 is moving from the first access point 31 toward the second access point 32 while maintaining its current connection with the first access point 31.

The first radio communication unit 101 measures RSSI of beacon signals received from the first access point 31. Suppose here that the first access point 31 exhibits its RSSI with a magnitude of RSSI_48. Since this RSSI is below the pre-handover scan threshold 51, the first radio communication unit 101 informs the scanning control unit 121 of a meaningful drop of RSSI (S120).

The scanning control unit 121 sends an RSSI drop notice to the handover control unit 123. Upon receipt, the handover control unit 123 searches the candidate channel table 113 for any candidate channel pertinent to the first access point 31. The handover control unit 123 then requests the scanning control unit 121 to perform a pre-handover scan with “ESSID_00” and candidate channel CH6 (S121).

The scanning control unit 121 causes the first radio communication unit 101 to execute a pre-handover scan. The first radio communication unit 101 scans candidate channel CH6 for the specified ESSID “ESSID_00,” using the unicast scheme for 2.4-GHz band. Specifically, the first radio communication unit 101 transmits a probe request in channel CH6 and receives a probe response from the second access point 32 (S122). Aside from unicast requesting in the candidate channel, the first radio communication unit 101 receives beacon signals from the first access point 31 to which the mobile communication apparatus 100 is currently connected. The first radio communication unit 101 returns a pre-handover scanning result, including information about the first access point 31.

Suppose here that the first access point 31 exhibits RSSI_47 while the second access point 32 exhibits RSSI_55. Since both RSSIs exceed the first detection threshold, the first radio communication unit 101 extracts the first access point 31 and second access points 32 and sends their pre-handover scanning result to the scanning control unit 121.

The scanning control unit 121 forwards the pre-handover scanning result to the handover control unit 123. The handover control unit 123 then calculates a difference between RSSI_55 (the maximum RSSI) and RSSI_47 (the RSSI of the currently connected access point 31), thus recognizing that the calculated RSSI difference is not greater than the handover start threshold 56. After a certain wait time (e.g., 5 seconds), the handover control unit 123 requests again the scanning control unit 121 to conduct a pre-handover scan (S123).

The scanning control unit 121 causes the first radio communication unit 101 to execute a pre-handover scan. The first radio communication unit 101 scans candidate channel CH6 for the specified ESSID “ESSID_00” in the same way as the foregoing step S122 (S124). Suppose that the first access point 31 now exhibits RSSI_47 and the second access point 32 RSSI_62. Since both RSSIs exceed the first detection threshold, the first radio communication unit 101 extracts the first access point 31 and second access points 32 and sends their pre-handover scanning result to the scanning control unit 121, including the information of these access points.

The scanning control unit 121 forwards the pre-handover scanning result to the handover control unit 123. The handover control unit 123 then calculates a difference between RSSI_62 (maximum RSSI) and RSSI_47 (RSSI of the currently connected access point 31), thus recognizing that the calculated RSSI difference exceeds the handover start threshold 56. Since this means the opportunity for a handover, the handover control unit 123 requests the first radio communication unit 101 to start a handover procedure with a specified BSSID, ESSID, and channel number (S125).

The first radio communication unit 101 executes a disconnection procedure from the first access point 31, while conducting a connection procedure with the second access point 32. After establishment of a connection to the second access point 32, the first radio communication unit 101 receives beacon signals from the second access point 32 at regular intervals (S126).

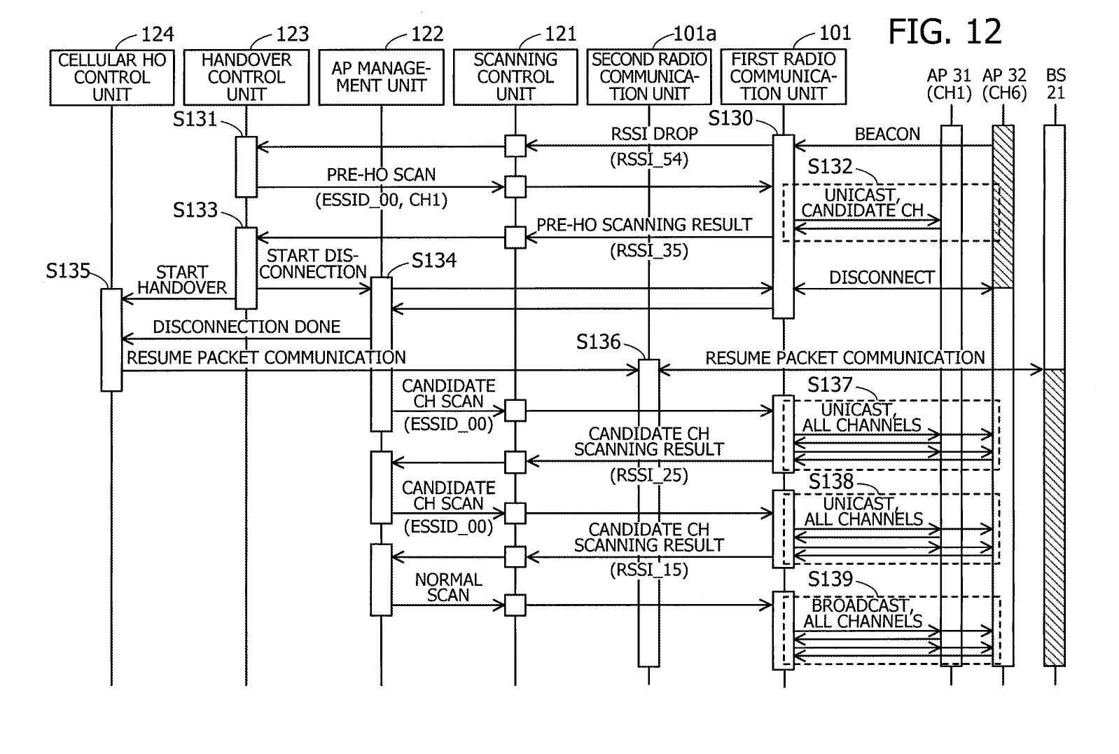

FIG. 12 is a third sequence diagram illustrating yet another example of communication in a handover environment. It is assumed in this example that the mobile communication apparatus 100 is moving away from the first and second access points 31 and 32 while maintaining its current connection with the second access point 32.

The first radio communication unit 101 measures RSSI of beacon signals received from the second access point 32. Suppose that the second access point 32 exhibits RSSI_54. Since this RSSI is below the pre-handover scan threshold 51, the first radio communication unit 101 informs the scanning control unit 121 of a drop of RSSI (S130).

The scanning control unit 121 forwards the RSSI drop notice to the handover control unit 123. Upon receipt of this information, the handover control unit 123 searches the candidate channel table 113 for any candidate channel pertinent to the second access point 32. The handover control unit 123 then requests the scanning control unit 121 to perform pre-handover scans with “ESSID_00” and candidate channel CH1 (S131).

The scanning control unit 121 causes the first radio communication unit 10 to execute a pre-handover scan. The first radio communication unit 101 scans candidate channel CH1 for the specified ESSID “ESSID_00,” using the unicast scheme for 2.4-GHz band. Specifically, the first radio communication unit 101 transmits a probe request in channel CH1 and receives a probe response from the first access point 31 (S132). At this point, the first radio communication unit 101 is still receiving beacon signals from the second access point 32 to which the mobile communication apparatus 100 is currently connected.

Suppose that the second access point 32 now exhibits RSSI_35 while RSSI of the first access point 31 is below or equal to the first detection threshold. Since the former RSSI exceeds the first detection threshold, the first radio communication unit 101 extracts the second access point 32 and sends its pre-handover scanning result to the scanning control unit 121, including the information of that access point.

The scanning control unit 121 forwards the pre-handover scanning result to the handover control unit 123, thus permitting it to recognize that RSSI of the second access point 32 is smaller than or equal to the disconnection threshold 53. Accordingly, the handover control unit 123 requests the AP management unit 122 to start disconnection, while commanding the cellular handover control unit 124 to start a handover (S133).

The AP management unit 122 requests the first radio communication unit 101 to start disconnection (S134). In response, the first radio communication unit 101 executes a disconnection procedure from the second access point 32 and notifies the AP management unit 122 of its completion. The AP management unit 122 sends a disconnection completion notice back to the cellular handover control unit 124. This disconnection completion notice, in combination with the above request for starting a handover, causes the cellular handover control unit 124 to command the second radio communication unit 101a to resume packet communication (S135). The second radio communication unit 101a communicates with the PDN 45 via the base station 21 to change its registration data (session information). After that, the second radio communication unit 101a resumes transmission and reception of packets to and from the base station 21 (S136).

Upon completion of a handover from the second access point 32 to the base station 21, the AP management unit 122 requests the scanning control unit 121 to start candidate channel scans, specifying “ESSID_00” of the previously connected access point 32. The scanning control unit 121 commands the first radio communication unit 101 to execute candidate channel scans. The scanning control unit 121 also reduces the RSSI threshold from the first detection threshold to the second detection threshold. The first radio communication unit 101 scans every channel, with the specified “ESSID_00” (S137).

Suppose here that the second access point 32 exhibits RSSI_25 while the first access point 31 is not detected. Since the detected RSSI exceeds the second detection threshold, the first radio communication unit 101 extracts the second access point 32 alone and sends this candidate channel scanning result to the scanning control unit 121. The scanning control unit 121 forwards the candidate channel scanning result to the AP management unit 122. The AP management unit 122 requests again the scanning control unit 121 to perform candidate channel scans because the previous scans failed to detect access points whose RSSIs exceed the connection threshold 52. The scanning control unit 121 commands the first radio communication unit 101 to execute candidate channel scans. The first radio communication unit 101 scans every channel, with the specified “ESSID_00” (S138).

Suppose now that the second access point 32 exhibits RSSI_15 while the first access point 31 is not detected. Since the detected RSSI still exceeds the second detection threshold, the first radio communication unit 101 extracts the second access point 32 and sends this candidate channel scanning result to the scanning control unit 121. The scanning control unit 121 forwards the candidate channel scanning result to the AP management unit 122. The AP management unit 122 recognizes that the RSSI does not exceed the scanning stop threshold 55, and thus determines to change scanning methods from candidate channel scan to normal scan. The AP management unit 122 then requests the scanning control unit 121 to perform normal scans.

The scanning control unit 121 causes the first radio communication unit 101 to execute normal scans. The first radio communication unit 101 accordingly scans all channels (S139), using the broadcast scheme (i.e., without specifying any particular ESSID) for 2.4-GHz band.

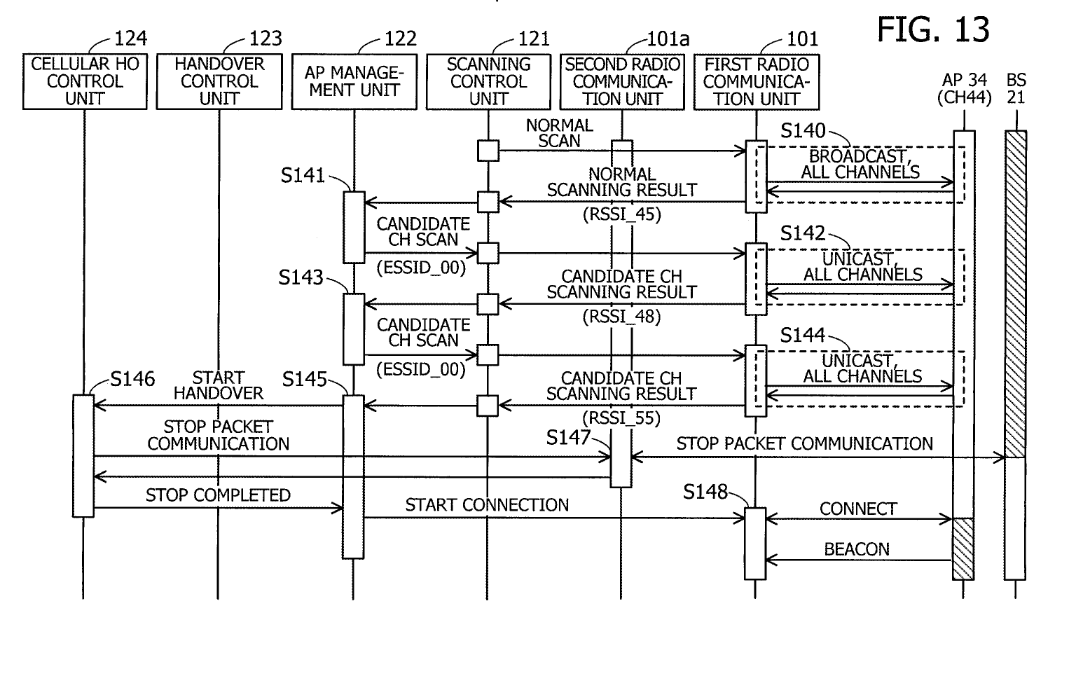

FIG. 13 is a first sequence diagram illustrating an example of communication in a single AP environment. It is assumed in this example that the mobile communication apparatus 100 is moving toward the fourth access point 34 while continuing data communication with the base station 21.

In the case where the wireless LAN function of the mobile communication apparatus 100 has been enabled by its user, the scanning control unit 121 requests the first radio communication unit 101 to conduct normal scans. The first radio communication unit 101 scans all channels accordingly, without any restrictions on ESSIDs. In the present example, the first radio communication unit 101 receives beacon signals that are sent from the fourth access point 34 over channel CH44 (S140). Suppose here that RSSI of the fourth access point 34 is RSSI_45. Since this RSSI exceeds the first detection threshold, the first radio communication unit 101 extracts the fourth access point 34 and sends this normal scanning result to the scanning control unit 121, including the information about the extracted access point 34.

The scanning control unit 121 forwards the normal scanning result to the AP management unit 122. The AP management unit 122 recognizes that the ESSID of the fourth access point 34 is recorded in the connection record table 111, and that its RSSI exceeds the candidate channel scan threshold 54. Accordingly, the AP management unit 122 requests the scanning control unit 121 to execute candidate channel scans, with “ESSID_00” of the fourth access point 34 (S141).

The scanning control unit 121 causes the first radio communication unit 101 to execute candidate channel scans. The scanning control unit 121 also reduces the RSSI threshold from the first detection threshold to the second detection threshold. The first radio communication unit 101 scans every channel, with the specified “ESSID_00.” Here the first radio communication unit 101 receives beacon signals sent from the fourth access point 34 over channel CH44 (S142). Suppose that RSSI of the fourth access point 34 has been increased to RSSI_48. Since the detected RSSI exceeds the second detection threshold, the first radio communication unit 101 extracts the fourth access point 34 and sends this candidate channel scanning result to the scanning control unit 121.

The scanning control unit 121 forwards the candidate channel scanning result to the AP management unit 122. Since the above candidate channel scans in step S142 have found only one access point, the AP management unit 122 determines that the mobile communication apparatus 100 currently resides in a single AP environment. In addition to the above, the AP management unit 122 recognizes that RSSI of the fourth access point 34 exceeds the candidate channel scan threshold 54, but not the connection threshold 52. Accordingly, the AP management unit 122 requests the scanning control unit 121 to execute candidate channel scans again, with “ESSID_00” of the fourth access point 34 (S143).

The scanning control unit 121 causes the first radio communication unit 101 to execute candidate channel scans. The first radio communication unit 101 scans every channel, with the specified “ESSID_00” (S144). Suppose here that the fourth access point 34 exhibits RSSI_55. Since the detected RSSI exceeds the second detection threshold, the first radio communication unit 101 extracts the fourth access point 34 and sends this candidate channel scanning result to the scanning control unit 121.

The scanning control unit 121 forwards the candidate channel scanning result to the AP management unit 122. Since the above candidate channel scans in step S144 have found only one access point, the AP management unit 122 determines that the mobile communication apparatus 100 currently resides in a single AP environment. The AP management unit 122 also recognizes that RSSI of the fourth access point 34 has exceeded the connection threshold 52. Accordingly, the AP management unit 122 determines to connect to the fourth access point 34, thus requesting the cellular handover control unit 124 to initiate a handover procedure (S145).

The cellular handover control unit 124 requests the second radio communication unit 101a to stop packet communication (S146). The second radio communication unit 101a stops transmission and reception of packets to and from the base station 21 and notifies the cellular handover control unit 124 of the completion of its request (S147). The cellular handover control unit 124 informs the AP management unit 122 that the packet communication is stopped. The AP management unit 122 now supplies BSSID, ESSID, channel number of the new access point 34 to the first radio communication unit 101, thus requesting to start connection.

The first radio communication unit 101 executes a connection procedure using channel CH44, thereby establishing a connection to the fourth access point 34. Upon completion, the first radio communication unit 101 communicates with the PDN 45 via the fourth access point 34, ePDG 43, and PWG 44 to change the session information. The first radio communication unit 101 receives beacon signals from the fourth access point 34 at regular intervals. When it is in the middle of voice packet communication, the first radio communication unit 101 resumes packet communication (S148).

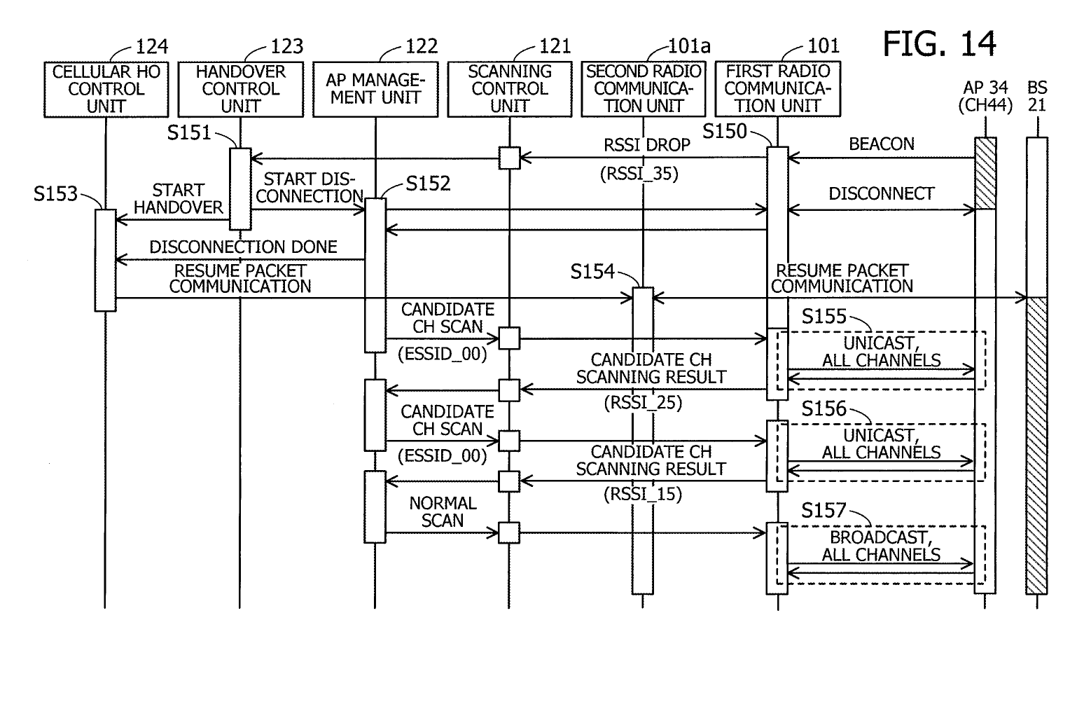

FIG. 14 is a second sequence diagram illustrating another example of communication in a single AP environment. It is assumed in this example that the mobile communication apparatus 100 is moving away from the fourth access point 34 while maintaining its current connection with that access point 34.

The first radio communication unit 101 measures RSSI of beacon signals received from the fourth access point 34. Suppose here that the fourth access point 34 exhibits RSSI_35. Since this RSSI is below the disconnection threshold 53, the first radio communication unit 101 informs the scanning control unit 121 of a drop of RSSI (S150). The scanning control unit 121 forwards this RSSI drop notice to the handover control unit 123, thus permitting it to recognize that RSSI of the fourth access point 34 is smaller than or equal to the disconnection threshold 53. Accordingly, the handover control unit 123 commands the AP management unit 122 to start disconnection, while requesting the cellular handover control unit 124 to start a handover (S151).

The AP management unit 122 requests the first radio communication unit 101 to start disconnection (S152). In response, the first radio communication unit 101 executes a disconnection procedure from the fourth access point 34 and notifies the AP management unit 122 of its completion. The AP management unit 122 sends a disconnection completion notice back to the cellular handover control unit 124. This disconnection completion notice, in combination with the above request for starting a handover, causes the cellular handover control unit 124 to command the second radio communication unit 101a to resume packet communication (S153). The second radio communication unit 101a communicates with the PDN 45 via the base station 21 to change its registration data (session information). The second radio communication unit 101a resumes transmission and reception of packets to and from the base station 21 (S154).

Upon completion of a handover from the fourth access point 34 to the base station 21, the AP management unit 122 requests the scanning control unit 121 to start candidate channel scans, specifying “ESSID_00” of the previous access point 34. The scanning control unit 121 accordingly causes the first radio communication unit 101 to execute candidate channel scans. The scanning control unit 121 also reduces the RSSI threshold from the first detection threshold to the second detection threshold. The first radio communication unit 101 scans every channel, with the specified “ESSID_00” (S155).

Suppose here that the fourth access point 34 exhibits RSSI_25. Since the detected RSSI exceeds the second detection threshold, the first radio communication unit 101 extracts the fourth access point 34 and sends this candidate channel scanning result to the scanning control unit 121. The scanning control unit 121 forwards the candidate channel scanning result to the AP management unit 122. The AP management unit 122 requests again the scanning control unit 121 to perform candidate channel scans. The scanning control unit 121 accordingly causes the first radio communication unit 101 to execute candidate channel scans. The first radio communication unit 101 scans every channel, with the specified “ESSID_00” (S156).

Suppose that the fourth access point 34 has further dropped its RSSI to RSSI_15. Since the detected RSSI still exceeds the second detection threshold, the first radio communication unit 101 extracts the fourth access point 34 and sends this candidate channel scanning result to the scanning control unit 121. The scanning control unit 121 forwards the candidate channel scanning result to the AP management unit 122. The AP management unit 122 now recognizes that the RSSI has dropped to or below the scanning stop threshold 55, and thus determines to change scanning methods from candidate channel scan to normal scan. The AP management unit 122 then requests the scanning control unit 121 to perform normal scans.

The scanning control unit 121 causes the first radio communication unit 101 to execute normal scans. The first radio communication unit 101 scans all channels without any restrictions on ESSID (S157). Note that the mobile communication apparatus 100 in a single AP environment does not initiate pre-handover scans even if RSSI of the fourth access point 34 falls to or below the pre-handover scan threshold 51.

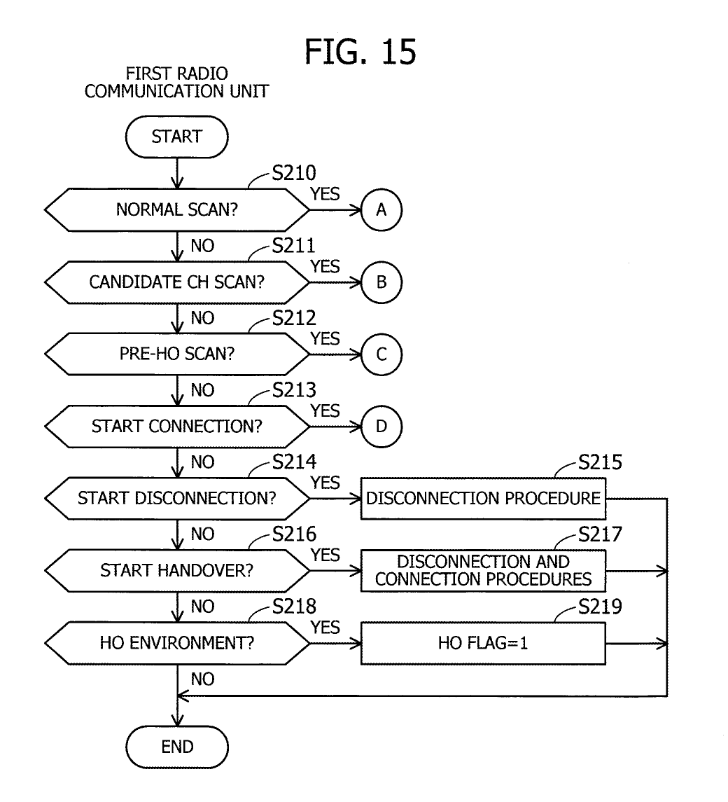

The description will now discuss what processes the proposed mobile communication apparatus 100 executes. FIG. 15 is a flowchart illustrating an exemplary procedure performed by the first radio communication unit.

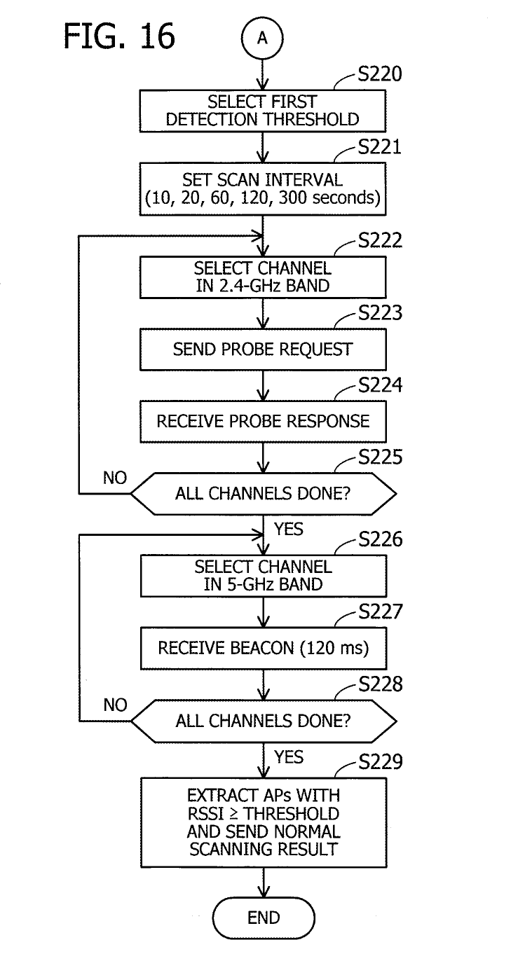

(S210) The first radio communication unit 101 receives a message from one of the scanning control unit 121, AP management unit 122, and handover control unit 123. The first radio communication unit 101 determines whether the received message is a request for normal scans from the scanning control unit 121. If it is, the process branches to step S220 in FIG. 16. Otherwise, the process proceeds to step S211.

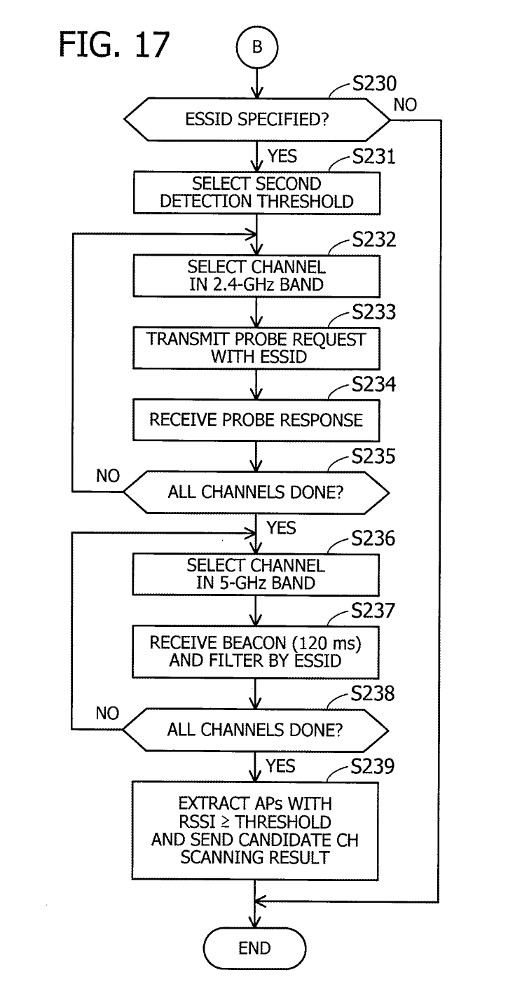

(S211) The first radio communication unit 101 determines whether the received message is a request for candidate channel scans from the scanning control unit 121. If it is, the process branches to step S230 in FIG. 17.

Otherwise, the process proceeds to step S212.

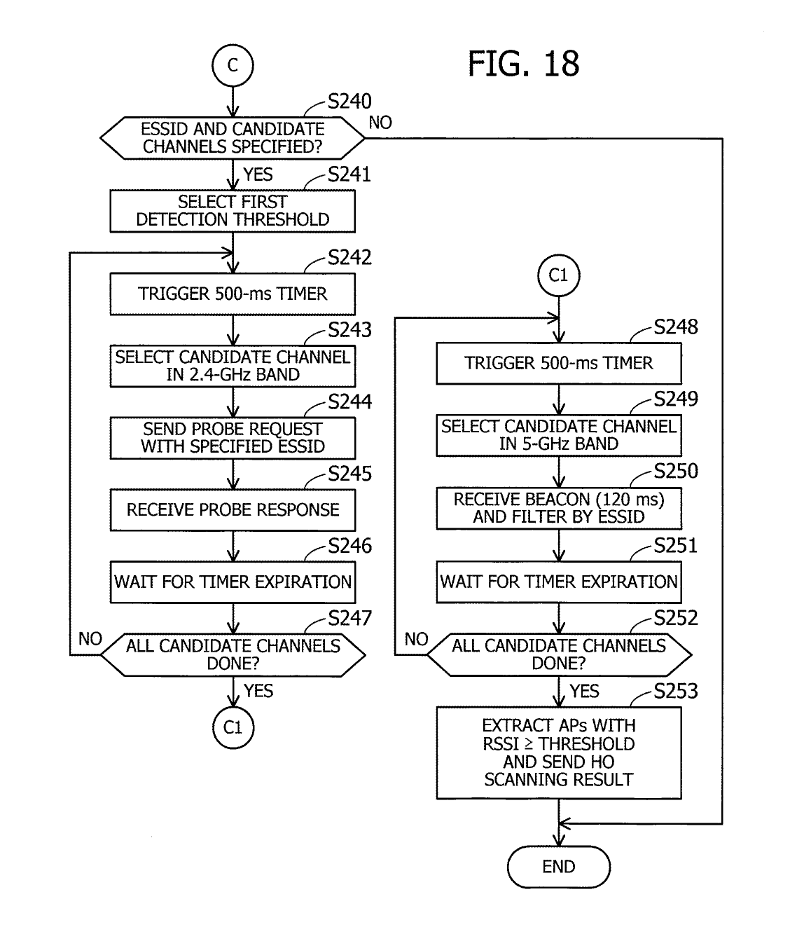

(S212) The first radio communication unit 101 determines whether the received message is a request for pre-handover scans from the scanning control unit 121. If it is, the process branches to step S240 in FIG. 18.

Otherwise, the process proceeds to step S213.

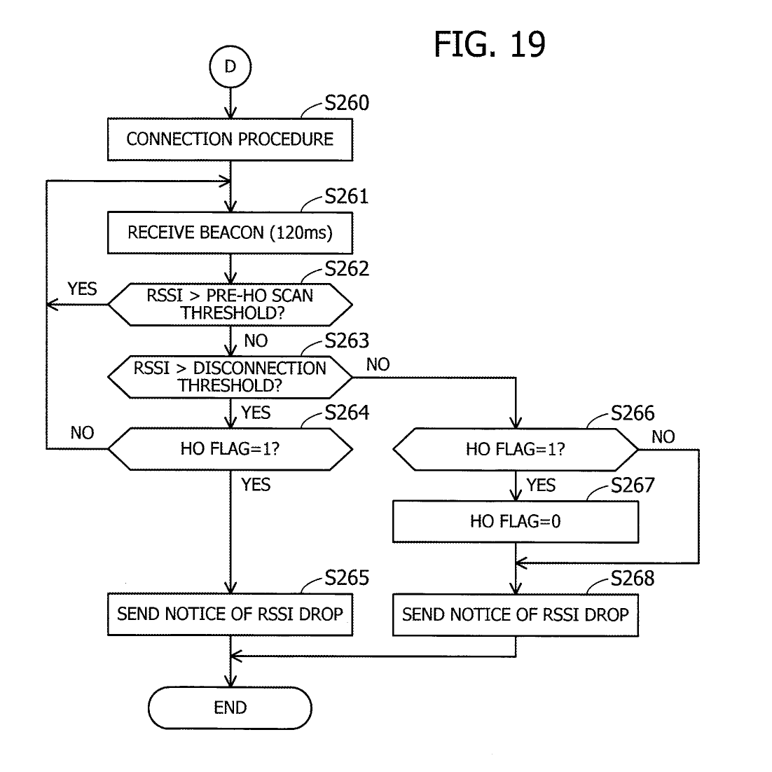

(S213) The first radio communication unit 101 determines whether the received message is a request from the AP management unit 122 for starting a connection. If it is, the process branches to step S260 in FIG. 19. Otherwise, the process proceeds to step S214.

(S214) The first radio communication unit 101 determines whether the received message is a request from the AP management unit 122 for starting disconnection from the current access point. If it is, the process branches to step S215. Otherwise, the process proceeds to step S216.

(S215) The first radio communication unit 101 executes a disconnection procedure to leave the current access point. The first radio communication unit 101 then exits from the process of FIG. 15.

(S216) The first radio communication unit 101 determines whether the received message is a request from the handover control unit 123 for starting a handover to a new access point. If it is, the process branches to step S217. Otherwise, the process proceeds to step S218.

(S217) The first radio communication unit 101 executes a disconnection procedure to leave the current access point, as well as performing a connection procedure to connect to a new access point specified by the handover control unit 123. The first radio communication unit 101 then exits from the process of FIG. 15.

(S218) The first radio communication unit 101 determines whether the received message provides information from the handover control unit 123 for notification of a handover environment. If it is, the process branches to step S219. Otherwise, the first radio communication unit 101 then exits from the process of FIG. 15.

(S219) The first radio communication unit 101 sets a handover flag (HO flag) to one. Specifically, the HO flag initially has a value of zero, and this step changes it to one.

FIG. 16 is another flowchart (continued from FIG. 15) illustrating an exemplary procedure performed by the first radio communication unit.

(S220) The first radio communication unit 101 selects the first detection threshold as a reference level for access point detection.

(S221) The first radio communication unit 101 sets a time interval for the next cycle of normal scans. More specifically, normal scans are executed at variable intervals which begin with 10 seconds and successively increases to 20 seconds, 60 seconds, 120 seconds, and 300 seconds, within the maximum limit of 300 seconds.

(S222) The first radio communication unit 101 selects one of thirteen channels in 2.4-GHz band. Note that the 2.4-GHz band accommodates the following channels: CH1, CH2, CH3, CH4, CH5, CH6, CH7, CH8, CH9, CH10, CH11, CH12, and CH13.

(S223) The first radio communication unit 101 transmits a probe request over the channel selected in step S222, without specifying any particular ESSID. In other words, the broadcast scan scheme is used.

(S224) The first radio communication unit 101 receives a probe response corresponding to the probe request transmitted in step S223. A probe response contains BSSID and ESSID of its source access point. Here the first radio communication unit 101 may receive two or more probe responses from different access points with different or identical ESSIDs. The first radio communication unit 101 may also not receive probe responses at all, meaning that the probe request has failed to reach any access point. The first radio communication unit 101 measures RSSI on the basis of received signals carrying a probe response.

(S225) The first radio communication unit 101 determines whether step S222 has selected all channels in 2.4-GHz band. If all 2.4-GHz channels are done, the process advances to step S226. If there is any pending channel, then the process returns to step S222.

(S226) The first radio communication unit 101 selects one of nineteen channels in 5-GHz band. Note that the 5-GHz band includes the following channels: CH36, CH40, CH44, CH48, CH52, CH56, CH60, CH64, CH100, CH104, CH108, CH112, CH116, CH120, CH124, CH128, CH132, CH136, and CH140.

(S227) The first radio communication unit 101 receives beacon signals in the channel selected in step S226. The first radio communication unit 101 may be able to receive one or two beacon signals from an access point during a period of 120 ms, when the mobile communication apparatus 100 is near to that access point. Each beacon signal contains BSSID and ESSID of its source access point. Here the first radio communication unit 101 may receive beacon signals from different access points with different or identical ESSIDs. It is also possible that no beacon signal is received at all. The first radio communication unit 101 measures RSSI on the basis of each beacon-carrying signal that is received.

(S228) The first radio communication unit 101 determines whether step S226 has selected all channels in 5-GHz band. If all 5-GHz channels are done, the process advances to step S229. If there is any pending channel, then the process returns to step S226.

(S229) The foregoing steps S224 and S227 have discovered one or more access points as the source of probe responses or beacon signals. The first radio communication unit 101 extracts all or some of those access points if their RSSI measurements exceed the first detection threshold. The first radio communication unit 101 then sends a normal scanning result to the scanning control unit 121. Specifically, this normal scanning result includes BSSID, ESSID, channel, and RSSI of each extracted access point.

FIG. 17 is yet another flowchart (continued from FIG. 15) illustrating an exemplary procedure performed by the first radio communication unit.

(S230) The first radio communication unit 101 determines whether the request for candidate channel scans specifies ESSID. If the request specifies ESSID, the process advances to step S231. If no ESSID is specified, the first radio communication unit 101 exits from the process of FIG. 17.

(S231) The first radio communication unit 101 selects the second detection threshold as a reference level for access point detection.

(S232) The first radio communication unit 101 selects one of the channels in 2.4-GHz band.

(S233) The first radio communication unit 101 transmits a probe request over the channel selected in step S232, with the specified ESSID of step S230. In other words, the unicast scan scheme is used.

(S234) The first radio communication unit 101 receives a probe response corresponding to the probe request transmitted in step S233. Note that such probe responses may arrive only from access points having the specified ESSID. It is also possible that no probe response is received at all. The first radio communication unit 101 measures RSSI on the basis of received signals carrying a probe response.

(S235) The first radio communication unit 101 determines whether step S232 has selected all channels in 2.4-GHz band. If all 2.4-GHz channels are done, the process advances to step S236. If there is any pending channel, then the process returns to step S232.

(S236) The first radio communication unit 101 selects one of the channels in 5-GHz band.

(S237) The first radio communication unit 101 receives beacon signals in the channel selected in step S236. Here the first radio communication unit 101 may receive one or more beacon signals from different access points with different or identical ESSIDs. It is also possible that no beacon signal is received at all. Here the first radio communication unit 101 filters out unnecessary beacons on the basis of ESSID. Specifically, the first radio communication unit 101 extracts beacons having the specified ESSID while discarding others. The first radio communication unit 101 measures RSSI on the basis of each beacon-carrying signal that is received.

(S238) The first radio communication unit 101 determines whether step S236 has selected all channels in 5-GHz band. If all 5-GHz channels are done, the process advances to step S239. If there is any pending channel, then the process returns to step S236.

(S239) The foregoing steps S234 and S237 have discovered one or more access points as the source of probe responses or beacon signals. The first radio communication unit 101 extracts all or some of those access points if their RSSI measurements exceed the second detection threshold. The first radio communication unit 101 then informs the scanning control unit 121 of this candidate channel scanning result. Specifically, the candidate channel scanning result includes BSSID, ESSID, channel, and RSSI of each extracted access point.

FIG. 18 is still another flowchart (continued from FIG. 15) illustrating an exemplary procedure performed by the first radio communication unit.

(S240) The first radio communication unit 101 determines whether the request for pre-handover scans specifies ESSID and candidate channels. If the request specifies them, the process advances to step S241. Otherwise, the first radio communication unit 101 exits from the process of FIG. 18.

(S241) The first radio communication unit 101 selects the first detection threshold as a reference level for access point detection.

(S242) The first radio communication unit 101 triggers a 500-ms timer. The first radio communication unit 101 may manage its timer functions by using its internal hardware timers or other outside hardware timers. It may also use software timers implemented with the CPU 102.

(S243) The above pre-handover scan request may specify candidate channels in 2.4-GHz band. The first radio communication unit 101 selects one of these 2.4-GHz candidate channels if any.

(S244) The first radio communication unit 101 transmits a probe request over the channel selected in step S243, with the specified ESSID. In other words, the unicast scan scheme is used in this probing.

(S245) The first radio communication unit 101 receives a probe response corresponding to the probe request transmitted in step S244. Note that such probe responses may arrive only from access points having the specified ESSID. It is also possible that no probe response is received at all. The first radio communication unit 101 measures RSSI on the basis of received signals carrying a probe response.

(S246) The first radio communication unit 101 waits until the 500-ms timer expires.

(S247) The first radio communication unit 101 determines whether step S243 has selected all candidate channels in 2.4-GHz band. If all such channels are done, the process advances to step S248. If there is any pending candidate channel, then the process returns to step S242.

(S248) The first radio communication unit 101 triggers a 500-ms timer.

(S249) The pre-handover scan request of interest may also specify candidate channels in 5-GHz band. The first radio communication unit 101 selects one of these 5-GHz candidate channels if any.

(S250) The first radio communication unit 101 receives beacon signals in the channel selected in step S249. Here the first radio communication unit 101 may receive one or more beacon signals from different access points with different or identical ESSIDs. It is also possible that no beacon signal is received at all. The first radio communication unit 101 filters out unnecessary beacons on the basis of ESSID. The first radio communication unit 101 measures RSSI on the basis of each beacon-carrying signal that is received.

(S251) The first radio communication unit 101 waits until the 500-ms timer expires.

(S252) The first radio communication unit 101 determines whether step S249 has selected all candidate channels in 5-GHz band. If all such channels are done, the process advances to step S253. If there is any pending channel, then the process returns to step S248.

(S253) The foregoing steps S245 and S250 have discovered one or more access points as the source of probe responses or beacon signals. The first radio communication unit 101 extracts all or some of those access points if their RSSI measurements exceed the first detection threshold. The first radio communication unit 101 then informs the scanning control unit 121 of this pre-handover scanning result. Specifically, the pre-handover scanning result includes BSSID, ESSID, channel, and RSSI of each extracted access point. Note that the first radio communication unit 101 is configured to make a pre-handover scanning result include information about the current access point when a beacon signal is received from that access point.

FIG. 19 is still another flowchart (continued from FIG. 15) illustrating an exemplary procedure performed by the first radio communication unit.

(S260) The first radio communication unit 101 executes a connection procedure to establish a connection with the access point that the AP management unit 122 specifies in its request for starting a new connection. Upon completion, the first radio communication unit 101 communicates with the PDN 45 via the new access point, ePDG 43, and PWG 44 to change the session information (registration data).

(S261) The first radio communication unit 101 receives beacon signals from the connected access point. Beacons are transmitted at regular intervals (e.g., about 100 ms). The first radio communication unit 101 measures RSSI on the basis of each beacon-carrying signal that is received.

(S262) The first radio communication unit 101 determines whether the RSSI measured in step S261 exceeds the pre-handover scan threshold 51. If the RSSI in question exceeds the pre-handover scan threshold 51, the process returns to step S261. Otherwise, the process advances to step S263.

(S263) The first radio communication unit 101 determines whether the RSSI measured in step S261 exceeds the disconnection threshold 53. If the RSSI in question exceeds the disconnection threshold 53, the process advances to step S264. Otherwise, the process proceeds to step S266.

(S264) The first radio communication unit 101 tests the current value of HO flag. If it is one, the process advances to step S265. If it is zero, the process returns to step S261.

(S265) The first radio communication unit 101 notifies the scanning control unit 121 of a drop of RSSI. This RSSI drop notice contains the BSSID, ESSID, channel number, and RSSI of the currently connected access point. The first radio communication unit 101 then exits from the process of FIG. 19.

(S266) The first radio communication unit 101 tests the current value of HO flag. If it is one, the process advances to step S267. If it is zero, the process skips to step S268.

(S267) The first radio communication unit 101 clears HO flag to zero.

(S268) The first radio communication unit 101 notifies the scanning control unit 121 of a drop of RSSI and exits from the process of FIG. 19.

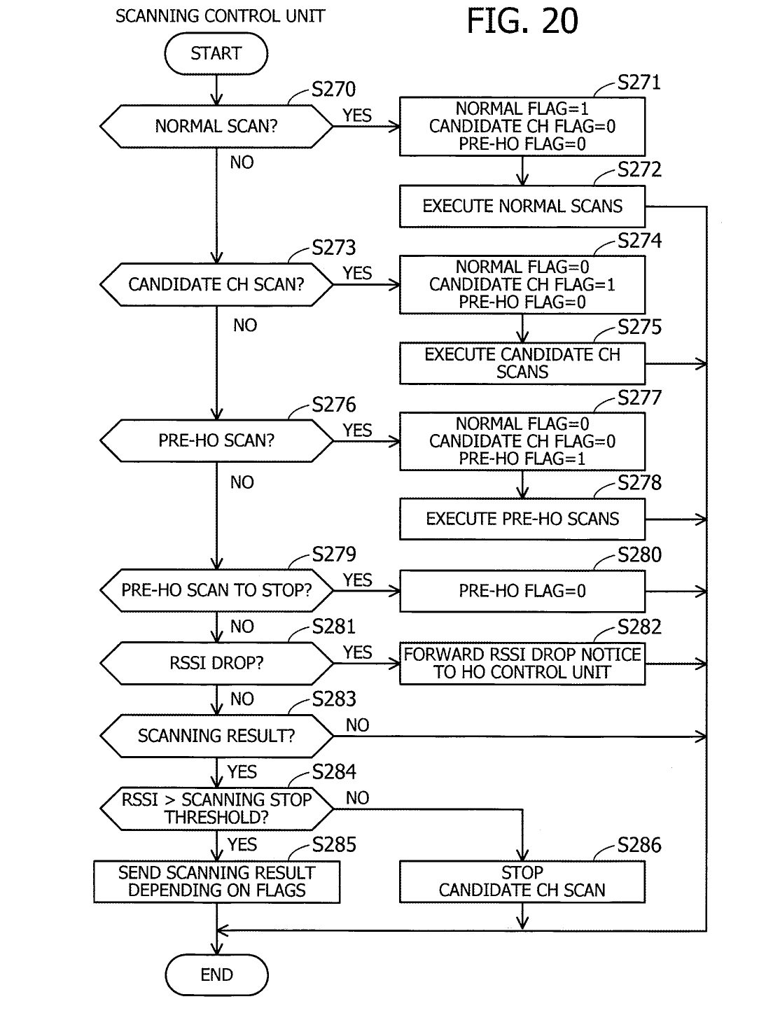

FIG. 20 is a flowchart illustrating an exemplary procedure performed by a scanning control unit.

(S270) The scanning control unit 121 receives a message from one of the first radio communication unit 101, AP management unit 122, and handover control unit 123. The scanning control unit 121 determines whether the received message is a request from the AP management unit 122 for normal scans. If it is, the process branches to step S271. Otherwise, the process proceeds to step S273.

(S271) The scanning control unit 121 sets the normal flag to one, while leaving the candidate channel flag and pre-HO flag in zeros. Note all the normal flag, candidate channel flag, and pre-HO flag have an initial value of zero.

(S272) The scanning control unit 121 causes the first radio communication unit 101 to execute normal scans, and exits from the process of FIG. 20.

(S273) The scanning control unit 121 determines whether the received message is a request from the AP management unit 122 for candidate channel scans. If it is, the process branches to step S274. Otherwise, the process proceeds to step S276.

(S274) The scanning control unit 121 sets the candidate channel flag to one, while leaving the normal flag and pre-HO flag in zeros.

(S275) The scanning control unit 121 causes the first radio communication unit 101 to execute candidate channel scans, and exits from the process of FIG. 20.

(S276) The scanning control unit 121 determines whether the received message is a request from the handover control unit 123 for pre-handover scans. If it is, the process branches to step S277. Otherwise, the process proceeds to step S279.

(S277) The scanning control unit 121 sets the pre-HO flag to one, while leaving the normal flag and candidate channel flag in zeros.

(S278) The scanning control unit 121 causes the first radio communication unit 101 to perform pre-handover scans, and exits from the process of FIG. 20.

(S279) The scanning control unit 121 determines whether the received message is a request from the handover control unit 123 for stopping pre-handover scans. If it is, the process branches to step S280. Otherwise, the process proceeds to step S281.

(S280) The scanning control unit 121 clears the pre-HO flag to zero and exits from the process of FIG. 20.

(S281) The scanning control unit 121 determines whether the received message is an RSSI drop notice from the first radio communication unit 101. If it is, the process branches to step S282. Otherwise, the process proceeds to step S283.

(S282) The scanning control unit 121 forwards the RSSI drop notice to the handover control unit 123 and exits from the process of FIG. 20.

(S283) The scanning control unit 121 determines whether the received message is a scanning result from the first radio communication unit 101. This scanning results may be a normal scanning result, a candidate channel scanning result, or a pre-handover scanning result. If the message conveys any such scanning result, the process advances to step S284. Otherwise, the scanning control unit 121 exits from the process of FIG. 20.

(S284) The scanning control unit 121 determines whether the scanning result contains an RSSI exceeding the scanning stop threshold 55. If it contains such an RSSI, the process advances to step S285. Otherwise, the process proceeds to step S286.

(S285) The scanning control unit 121 sends the scanning result to either the AP management unit 122 or the handover control unit 123, depending on the states of the above three flags. More specifically, the scanning result in question is a pre-handover scanning result when pre-HO flag=1. In this case, the scanning control unit 121 supplies the pre-handover scanning result to the handover control unit 123. When normal flag=1, the scanning result in question is a normal scanning result. In this case, the scanning control unit 121 supplies the normal scanning result to the AP management unit 122. When candidate channel flag=1, the scanning result in question is a candidate channel scanning result. In this case, the scanning control unit 121 supplies the candidate channel scanning result to the AP management unit 122. The scanning control unit 121 then exits from the process of FIG. 20.

(S286) The scanning control unit 121 causes the AP management unit 122 to stop candidate channel scans.

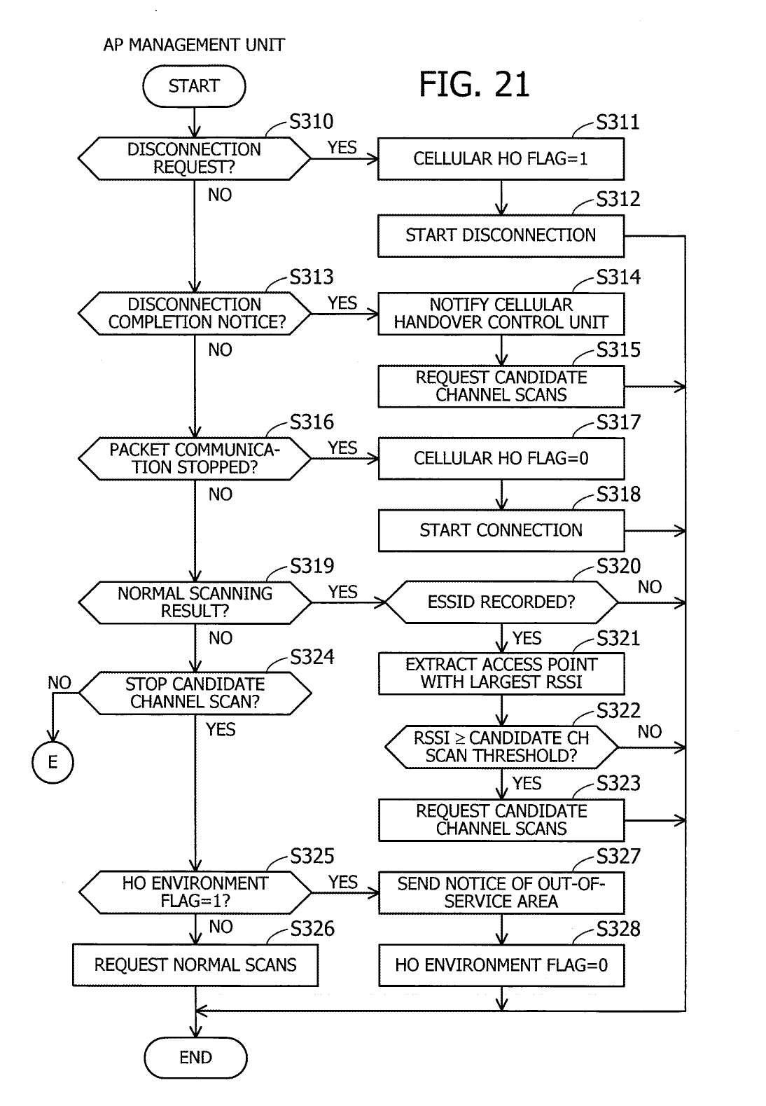

FIG. 21 is a flowchart illustrating an exemplary procedure performed by an AP management unit.

(S310) The AP management unit 122 receives a message from one of the first radio communication unit 101, scanning control unit 121, and handover control unit 123. The AP management unit 122 determines whether the received message is a request from the handover control unit 123 for starting disconnection. If it is, the process branches to step S311. Otherwise, the process proceeds to step S313.

(S311) The AP management unit 122 sets a cellular HO flag to one. Note that the cellular HO flag was initialized previously to zero.

(S312) The AP management unit 122 causes the first radio communication unit 101 to start disconnection, and exits from the process of FIG. 21.

(S313) The AP management unit 122 determines whether the received message is a disconnection completion notice from the first radio communication unit 101. If it is, the process branches to step S314. Otherwise, the process proceeds to step S316.

(S314) The AP management unit 122 notifies the cellular handover control unit 124 of the completion of disconnection.

(S315) The AP management unit 122 requests the scanning control unit 121 to perform candidate channel scans with ESSID of the previous access point. The AP management unit 122 then exits from the process of FIG. 21.

(S316) The AP management unit 122 determines whether the received message is from the cellular handover control unit 124 and indicates that the packet communication is stopped. If it is, the process branches to step S317. Otherwise, the process proceeds to step S319.

(S317) The AP management unit 122 clears the cellular HO flag to zero.

(S318) The AP management unit 122 causes the first radio communication unit 101 to start connection to a new access point. Here the AP management unit 122 specifies BSSID, ESSID, and channel number of the access point. The AP management unit 122 then exits from the process of FIG. 21.

(S319) The AP management unit 122 determines whether the received message is a normal scanning result from the scanning control unit 121. If it is, the process branches to step S320. Otherwise, the process proceeds to step S324.

(S320) The normal scanning result may indicate access points whose ESSIDs are recorded in the connection record table 111 (meaning that the mobile communication apparatus 100 visited those access points in the past). The AP management unit 122 seeks such access points in the received normal scanning result. The AP management unit 122 determines whether it has extracted at least one such access point, and if so, the process advances to step S321. Otherwise, the AP management unit 122 exits from the process of FIG. 21.

(S321) The AP management unit 122 extracts one of the access points of step S320 that has the largest RSSI.

(S322) The AP management unit 122 determines whether RSSI of the access point extracted in step S321 exceeds the candidate channel scan threshold 54. If the RSSI in question exceeds the candidate channel scan threshold 54, the process returns to step S323. Otherwise, the AP management unit 122 exits from the process of FIG. 21.

(S323) The AP management unit 122 requests the scanning control unit 121 to perform candidate channel scans with ESSID of the access point extracted in step S321. The AP management unit 122 then exits from the process of FIG. 21.

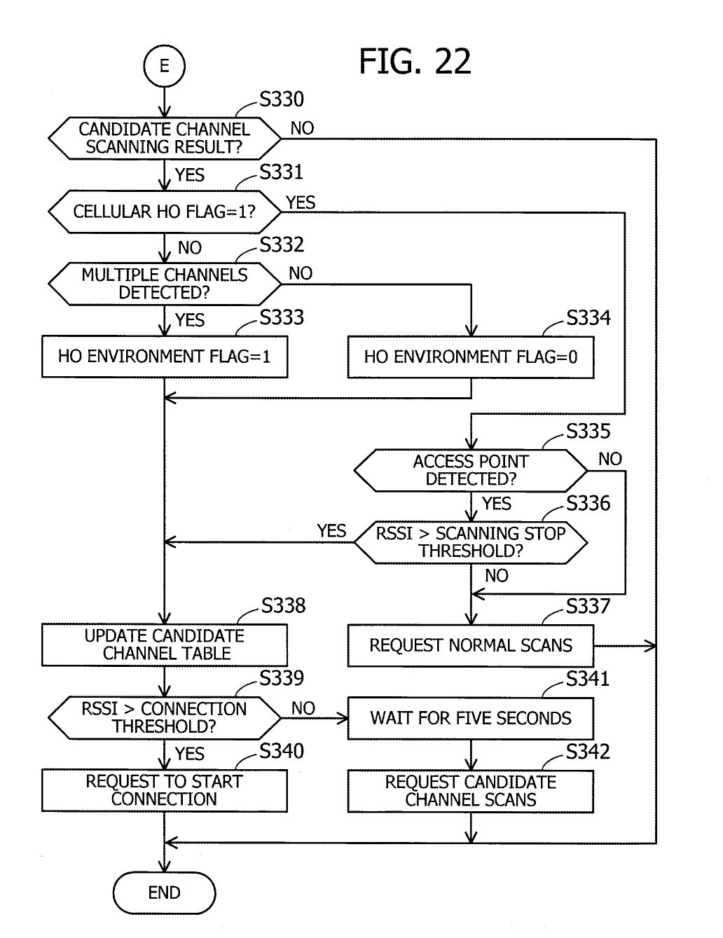

(S324) The AP management unit 122 determines whether the received message is a request from the scanning control unit 121 for stopping candidate channel scans. If it is, the process advances to step S325. Otherwise, the process proceeds to step S330 in FIG. 22.

(S325) The AP management unit 122 determines whether the HO environment flag is set to one. If the HO environment flag is one, the process proceeds to step S327. If the HO environment flag is zero, the process advances to step S326. Note that the HO environment flag initially had a value of zero.

(S326) The AP management unit 122 requests the scanning control unit 121 to perform normal scans, and exits from the process of FIG. 21.

(S327) The AP management unit 122 notifies the handover control unit 123 that the mobile communication apparatus 100 is out of the service area.

(S328) The AP management unit 122 clears the HO environment flag to zero.

FIG. 22 is another part of the flowchart (continued from FIG. 21) illustrating an exemplary procedure performed by an AP management unit.

(S330) The AP management unit 122 determines whether the received message is a candidate channel scanning result from the scanning control unit 121. If it is, the process advances to step S331. Otherwise, the AP management unit 122 exits from the process of FIG. 22.

(S331) The AP management unit 122 determines whether the cellular HO flag is set to one. If the cellular HO flag is one, the process proceeds to step S335. If the cellular HO flag is zero, the process advances to step S332.

(S332) The AP management unit 122 determines whether the candidate channel scanning result contains information about multiple access points. In other words, it determines whether the candidate channel scans have detected two or more access points with identical ESSIDs, but in different channels. If this is the case, the process advances to step S333. Otherwise, the process advances to step S334.

(S333) The AP management unit 122 determines that the mobile communication apparatus 100 currently resides in a handover environment, thus setting the HO environment flag to one. The process then advances to step S338.

(S334) The AP management unit 122 determines that the mobile communication apparatus 100 currently resides in a single AP environment, thus setting the HO environment flag to zero. The process then advances to step S338.

(S335) The AP management unit 122 determines whether the preceding candidate channel scans have detected at least one access point. If so, the process advances to step S336. If no access point has been detected, then the process skips to step S337.

(S336) The AP management unit 122 extracts the largest RSSI that the candidate channel scanning result indicates and determines whether the extracted RSSI exceeds the scanning stop threshold 55. If the RSSI in question exceeds the scanning stop threshold 55, the process proceeds to step S338. Otherwise, the process advances to step S337.

(S337) The AP management unit 122 requests the scanning control unit 121 to perform normal scans, and exits from the process of FIG. 22.

(S338) The AP management unit 122 updates the candidate channel table 113 according to the candidate channel scanning result. More specifically, the AP management unit 122 registers BSSID, ESSID, and channel number of a detected access point when the access point has no entry in the candidate channel table 113. In the case where two or more access points are detected in different channels, the AP management unit 122 associates their channel numbers with each other by registering them as candidate channels in the candidate channel table 113.

(S339) The AP management unit 122 extracts the largest RSSI that the candidate channel scanning result indicates and then determines whether the extracted RSSI exceeds the connection threshold 52. If the RSSI in question exceeds the connection threshold 52, the process advances to step S340. Otherwise, the process proceeds to step S341.

(S340) The AP management unit 122 requests the first radio communication unit 101 to start connection, and exits from the process of FIG. 22.

(S341) The AP management unit 122 triggers a 5-second timer and waits until the timer expires.

(S342) The AP management unit 122 requests the scanning control unit 121 to perform candidate channel scans with the same ESSID used in the previous scan.

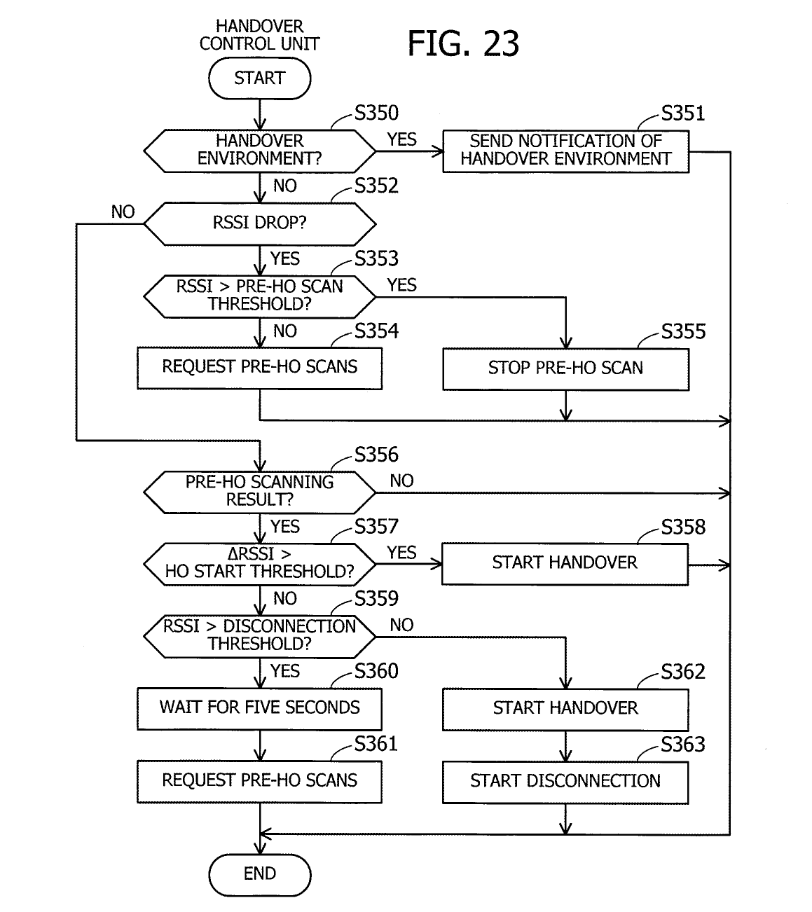

FIG. 23 is a flowchart illustrating an exemplary procedure performed by a handover control unit.

(S350) The handover control unit 123 receives a message from the scanning control unit 121 or AP management unit 122. The handover control unit 123 determines whether the received message provides information from the AP management unit 122 for notification of handover environment. If it does, the process branches to step S351. Otherwise, the process proceeds to step S352.

(S351) The handover control unit 123 notifies the first radio communication unit 101 of the handover environment. This notification enables the first radio communication unit 101 to issue an RSSI drop notice when RSSI of the current access point falls to or below the pre-handover scan threshold 51. The handover control unit 123 exits from the process of FIG. 23.

(S352) The handover control unit 123 determines whether the received message is an RSSI drop notice from the scanning control unit 121. If it is, the process advances to step S353. Otherwise, the process proceeds to step S356.

(S353) The handover control unit 123 determines whether the RSSI indicated in the RSSI drop notice exceeds the pre-handover scan threshold 51. If the RSSI in question exceeds the pre-handover scan threshold 51, the process proceeds to step S355. Otherwise, the process advances to step S354.

(S354) The handover control unit 123 searches the candidate channel table 113 for any candidate channel pertinent to the current access point. The handover control unit 123 then requests the scanning control unit 121 to perform pre-handover scans with ESSID of the current access point, as well as in the candidate channels pertinent thereto. The handover control unit 123 then exits from the process of FIG. 23.

(S355) The handover control unit 123 requests the scanning control unit 121 to stop pre-handover scans and then exits from the process of FIG. 23.

(S356) The handover control unit 123 determines whether the received message is a pre-handover scanning result from the scanning control unit 121. If it is, the process advances to step S357. Otherwise, the handover control unit 123 exits from the process of FIG. 23.

(S357) The handover control unit 123 calculates a difference ΔRSSI between the largest RSSI in the received pre-handover scanning result and the RSSI of the current access point. The handover control unit 123 then determines whether the former RSSI exceeds the latter RSSI, as well as whether ΔRSSI is greater than the handover start threshold 56. If both conditions are met, the process advances to step S358. Otherwise, the process proceeds to step S359.

(S358) The handover control unit 123 causes the first radio communication unit 101 to start a handover, and exits from the process of FIG. 23.

(S359) The handover control unit 123 determines whether RSSI of the current access point exceeds the disconnection threshold 53. If the RSSI in question exceeds the disconnection threshold 53, the process advances to step S360. Otherwise, the process proceeds to step S362.

(S360) The handover control unit 123 triggers a 5-second timer and waits until the timer expires.

(S361) The handover control unit 123 requests the scanning control unit 121 to perform pre-handover scans, and exits from the process of FIG. 23.

(S362) The handover control unit 123 requests the cellular handover control unit 124 to start a handover.

(S363) The handover control unit 123 requests the AP management unit 122 to start disconnection.

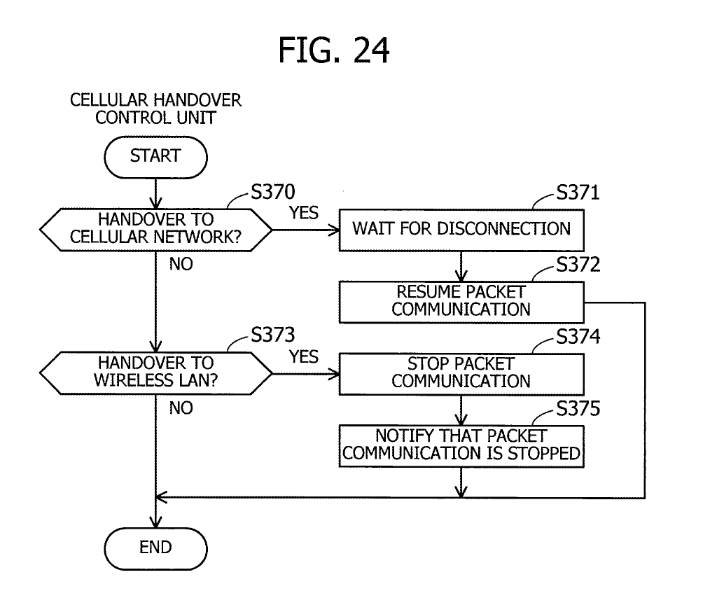

FIG. 24 is a flowchart illustrating an exemplary procedure performed by a cellular handover control unit.

(S370) The cellular handover control unit 124 receives a message from the AP management unit 122 or handover control unit 123. The cellular handover control unit 124 determines whether the received message is from the handover control unit 123 and requesting to start a handover from the wireless LAN 30 to the cellular network 20. If it is, the process branches to step S371. Otherwise, the process proceeds to step S373.

(S371) The cellular handover control unit 124 waits for a disconnection completion notice from the AP management unit 122.

(S372) The cellular handover control unit 124 requests the second radio communication unit 101a to resume packet communication, and exits from the process of FIG. 24.

(S373) The cellular handover control unit 124 determines whether the received message is from the AP management unit 122 and requesting to start a handover from the cellular network 20 to the wireless LAN 30. If it is, the process proceeds to step S374. Otherwise, the cellular handover control unit 124 exits from the process of FIG. 24.

(S374) The cellular handover control unit 124 requests the second radio communication unit 101a to stop packet communication and then is notified of its completion from the second radio communication unit 101a.

(S375) Upon receipt of the above notice, the cellular handover control unit 124 sends a completion notice to the AP management unit 122 to indicate that the packet communication is stopped.

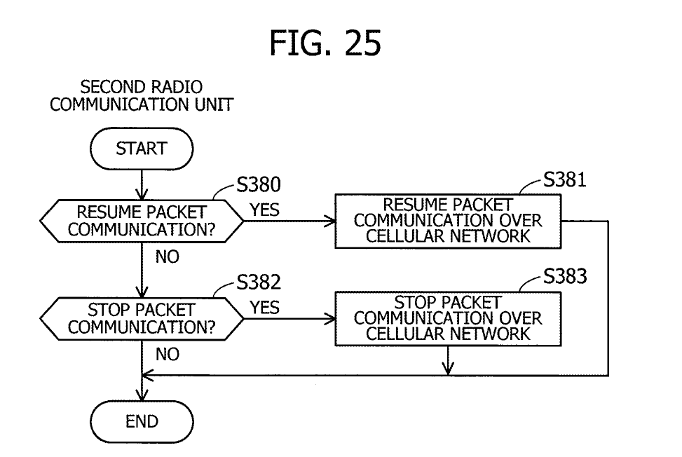

FIG. 25 is a flowchart illustrating an exemplary procedure performed by the second radio communication unit.

(S380) The second radio communication unit 101a receives a message from the cellular handover control unit 124. The second radio communication unit 101a determines whether the received message requests to resume packet communication. If it does, the process branches to step S381. Otherwise, the process proceeds to step S382.

(S381) The second radio communication unit 101a resumes packet communication over the cellular network 20. That is, an update of registration data (session information) is made from the base station 21 to the PDN 45, so that the transmission path of packets is switched from the wireless LAN 30 to the cellular network 20. The second radio communication unit 101a exits from the process of FIG. 25.

(S382) The second radio communication unit 101a determines whether the received message requests to stop packet communication. If it is, the process branches to step S383. Otherwise, the second radio communication unit 101a exits from the illustrated process.

(S383) The second radio communication unit 101a stops packet communication over the cellular network 20. That is, the transmission path of packets is switched from the cellular network 20 to the wireless LAN 30.

According to the proposed radio communication system of the second embodiment, scanning methods are switched from normal scans to ESSID-restricted candidate channel scans when a normal scan detects an access point whose RSSI exceeds a candidate channel scan threshold 54. Candidate channel scans take place at shorter intervals than normal scans. This feature of the second embodiment permits the mobile communication apparatus 100 to keep track of variations in RSSI with accuracy, besides reducing operational load. Candidate channel scans also reduce the risk of losing sight of the detected access point under cover of many other surrounding access points. The proposed techniques thus make it easy to track the detected access point and readily establish a connection with that access point when its RSSI exceeds a connection threshold 52.

The connection threshold 52 may be set to a higher value so that the mobile communication apparatus 100 hands over its communication to the wireless LAN 30 when the new access point reaches a sufficiently large RSSI. This raised threshold maintains the quality of communication during a period immediately after a handover to the wireless LAN 30. Similarly, the disconnection threshold 53 may be raised for earlier handover back to the cellular network 20, so as not to degrade the communication immediately before such a handover. The quality of voice calls is ensured even if the mobile communication apparatus 100 moves between the cellular network 20 and wireless LAN 30 during the call session.

Candidate channel scans may detect a plurality of access points having the same ESSID. The proposed mobile communication apparatus 100 determines it to be a handover environment and thus initiates pre-handover scans with restricted ESSID and channels when there is an ongoing session with the current access point. This feature of the second embodiment enables seamless handover between access points of the wireless LAN 30. Since channels are limited, the pre-handover scans consume less time, thus making it possible to shorten the possible disruption time and reduce its disturbance in the communication with the current access point.

The threshold for access point detection in candidate channel scans may be set lower than those in normal scans and pre-handover scans. This setup enables detection of farther access points and thus makes it easier to find handover environments. The connection threshold 52 is given a larger value than the disconnection threshold 53 to prevent the mobile communication apparatus 100 from being frequently handed over between the cellular network 20 and wireless LAN 30. Further, the candidate channel scan threshold 54 may be larger than the scanning stop threshold 55 in order to avoid often switching between candidate channel scan and normal scan.

As stated previously, the features of the first embodiment are achieved by causing the mobile communication apparatus 10 to execute a communication control program. Likewise, the features of the second embodiment are achieved by causing the mobile communication apparatus 100 to execute a communication control program.

The noted communication control programs may be recorded on a computer-readable storage medium, such as a magnetic disk, optical disc, magneto-optical disc, and semiconductor memory device. Magnetic disks include Flexible Disk (FD) and HDD. Optical discs include, for example, compact disc (CD), CD-Recordable (CD-R), CD-Rewritable (CD-RW), digital versatile disc (DVD), DVD-R, and DVD-RW. Portable storage media may be used for distributing communication control programs. In that case, the stored communication control programs may be copied from a portable storage medium to another storage medium (e.g., non-volatile memory 104) before they are executed.

Various embodiments and their variations have been discussed above. In one aspect, the proposed techniques reduce the possibility of missing an opportunity of connecting to an access point.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A mobile communication apparatus comprising:
a first radio communication interface that performs communication over a first radio communication network;
a second radio communication interface that executes a first scan to detect an access point of a second radio communication network and measure a signal level of reception signals received from the detected access point; and
a processor configured to perform a procedure including:
causing the second radio communication interface to execute a second scan that specifies an identifier of the detected access point so as to restrict scanning to a smaller range of access points than the first scan, when the signal level calculated in the first scan is smaller than or equal to a first threshold, but exceeds a second threshold, and
switching a path of the communication from the first radio communication network to the second radio communication network when a signal level calculated in the second scan for the detected access point exceeds the first threshold.

2. The mobile communication apparatus according to claim 1, wherein the second scan is repetitively executed at shorter intervals than the first scan.

3. The mobile communication apparatus according to claim 1, wherein the procedure further includes:
causing, when the path of the communication is returned from the second radio communication network to the first radio communication network, the second radio communication interface to execute a third scan that specifies an identifier of an access point to which the mobile communication apparatus has been connected before the path is returned to the first radio communication network, so as to restrict scanning to a smaller range of access points than the first scan.

4. The mobile communication apparatus according to claim 3, wherein the third scan is repeated when a signal level calculated in the third scan is smaller than or equal to the first threshold, but exceeds a third threshold that is smaller than the second threshold.

5. A radio communication method comprising:
performing, by a mobile communication apparatus, communication over a first radio communication network;
executing, by the mobile communication apparatus, a first scan to detect an access point of a second radio communication network and measure a signal level of reception signals received from the detected access point;
executing, by the mobile communication apparatus, a second scan that specifies an identifier of the detected access point so as to restrict scanning to a smaller range of access points than the first scan, when the signal level calculated in the first scan is smaller than or equal to a first threshold, but exceeds a second threshold; and
switching, by the mobile communication apparatus, a path of the communication from the first radio communication network to the second radio communication network when a signal level calculated in the second scan for the detected access point exceeds the first threshold.

6. A non-transitory computer-readable storage medium storing a program, wherein the program causes a computer included in a mobile communication apparatus to perform a procedure comprising:
performing communication over a first radio communication network;
executing a first scan to detect an access point of a second radio communication network and measure a signal level of reception signals received from the detected access point;
executing a second scan that specifies an identifier of the detected access point so as to restrict scanning to a smaller range of access points than the first scan, when the signal level calculated in the first scan is smaller than or equal to a first threshold, but exceeds a second threshold; and
switching a path of the communication from the first radio communication network to the second radio communication network when a signal level calculated in the second scan for the detected access point exceeds the first threshold.
